(19) United States
(12) Patent Application Publication
(10) Pub. No.: US 2026/0267244 A1
(43) Pub. Date: Sep. 10, 2026

(54) ELECTROPHOTOGRAPHIC PHOTORECEPTOR, PROCESS CARTRIDGE, AND IMAGE FORMING APPARATUS

(71) Applicant: KYOCERA DOCUMENT SOLUTIONS INC., OSAKA-SHI, OSAKA (JP)

(72) Inventors: RYOTA MORIKAWA, OSAKA-SHI, OSAKA (JP); DAISUKE KUBOSHIMA, OSAKA-SHI, OSAKA (JP); KATSUNORI TERAOKA, OSAKA-SHI, OSAKA (JP); KAZUTAKA SUGIMOTO, OSAKA-SHI, OSAKA (JP); HIROKI OTSUKA, OSAKA-SHI, OSAKA (JP)

(21) Appl. No.: 19/166,486

(22) PCT Filed: May 20, 2024
(86) PCT No.: PCT/JP2024/018502

§ 371 Date: Sep. 18, 2025

(30) Foreign Application Priority Data
Mar. 23, 2023 (JP) 2023-046542

(51) Int. Cl. G03G 5/06; G03G 5/047; G03G 5/147; G03G 15/02

(52) U.S. Cl. CPC G03G 5/06145; G03G 5/047; G03G 5/0609; G03G 5/0696; G03G 5/14734; G03G 15/0216; G03G 2215/00957; G03G 2215/00962; G03G 2221/183

(57) ABSTRACT

An electrophotographic photoreceptor includes a conductive substrate, a photosensitive layer, and a protective layer. The protective layer is a top surface layer of the electrophotographic photoreceptor. The protective layer includes a photocurable resin. The photosensitive layer includes a charge generating agent and a hole transporting agent. The hole transporting agent has a molecular weight of 580 or more and includes a compound represented by a formula (1), (2), (3), or (4).

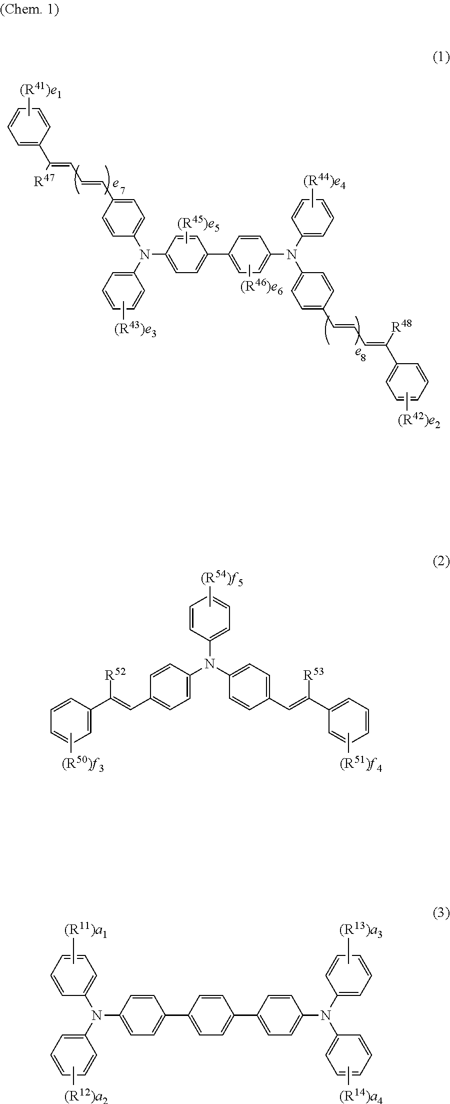

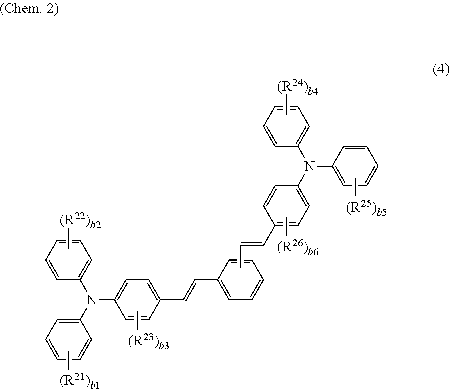

### FIELD OF THE DISCLOSURE

The present invention relates to an electrophotographic photoreceptor, a process cartridge, and an image forming apparatus.

### BACKGROUND OF THE DISCLOSURE

When an image forming apparatus including an electrophotographic photoreceptor is used to form images repeatedly, the electrophotographic photoreceptor gradually wears out in some cases. In order to suppress wear and extend the lifetime of the electrophotographic photoreceptor, a hard protective layer is provided on the surface of the electrophotographic photoreceptor in some cases. For example, the electrophotographic photoreceptor disclosed in Patent Literature 1 includes a photosensitive layer that contains a charge generating substance and a charge transporting substance in the same layer on a conductive support. A protective layer is provided on the photosensitive layer. The volume resistivity of the protective layer is smaller than the volume resistivity of the photosensitive layer.

### CITATION LIST

### Patent Literature

Patent Literature 1: Japanese Patent Application Laid-open No. 2010-286707

### SUMMARY OF THE DISCLOSURE

### Technical Problem

However, the electrophotographic photoreceptor disclosed in Patent Literature 1 is not intended to include a photocurable resin in the protective layer thereof. The present inventors' study has revealed that in the case where the protective layer includes a photocurable resin, an overshoot of the charging potential is likely to occur in the electrophotographic photoreceptor.

The present invention has been made in view of the above problem, and an object thereof is to provide an electrophotographic photoreceptor, a process cartridge, and an image forming apparatus that has excellent wear resistance and are capable of suppressing the overshoot of the charging potential even in the case where the protective layer includes a photocurable resin.

### Means for Solving the Problem

The electrophotographic photoreceptor according to the present invention includes a conductive substrate, a photosensitive layer, and a protective layer. The protective layer is a top surface layer of the electrophotographic photoreceptor and includes a photocurable resin. The photosensitive layer includes a charge generating agent and a hole transporting agent. The hole transporting agent includes a compound that has a molecular weight of 580 or more and is represented by a formula (1), (2), (3), or (4).

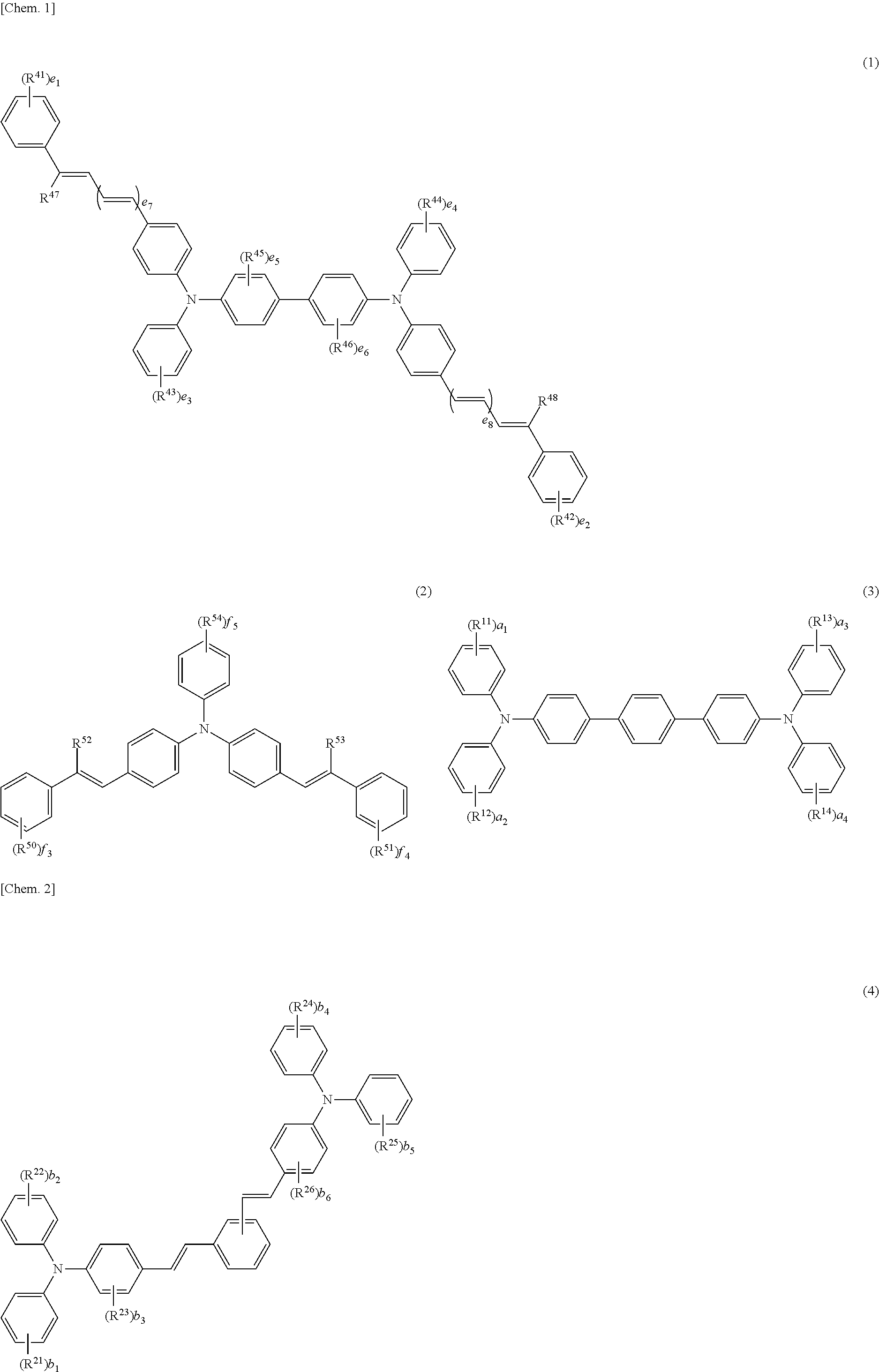

In the formula (1), R⁴¹, R⁴², R⁴³, R⁴⁴, R⁴⁵, and R⁴⁶ each independently represent an alkyl group having 1 or more and 8 or less carbon atoms or a phenyl group, R⁴⁷ and R⁴⁸ each independently represent a hydrogen atom, an alkyl group having 1 or more and 8 or less carbon atoms, or a phenyl group, e₁, e₂, e₃, and e₄ each independently represent an integer of 0 or more and 5 or less, e₅ and e₆ each independently represent an integer of 0 or more and 4 or less, and e₇ and e₅ each independently represent 0 or 1. In the formula (2), R⁵⁰, R⁵¹, and R⁵⁴ each independently represent an alkyl group having 1 or more and 8 or less carbon atoms or a phenyl group, R⁵² and R⁵³ each independently represent a hydrogen atom, an alkyl group having 1 or more and 8 or less carbon atoms, or a phenyl group that may be substituted with an alkyl group having 1 or more and 8 or less carbon atoms, and f₃, f₄, and f₅ each independently represent an integer of 0 or more and 5 or less. In the formula (3), R¹¹, R¹², R¹³, and R¹⁴ each independently represent an alkyl group having 1 or more and 8 or less carbon atoms or a phenyl group, and a₁, a₂, a₃, and a₄ each independently represent an integer of 0 or more and 5 or less. In the formula (4), R²¹, R²², R²³, R²⁴, R²⁵, and R²⁶ each independently represent an alkenyl group having 2 or more and 6 or less carbon atoms that may be substituted with at least one phenyl group or an alkyl group having 1 or more and 8 or less carbon atoms, b1, b2, b4, and b5 each independently represent an integer of 0 or more and 5 or less, and b3 and b6 each independently represent an integer of 0 or more and 4 or less.

A process cartridge according to the present invention includes at least one selected from the group consisting of a charging device, an exposure device, a development device, a transfer device, a cleaning member, a rubbing roller, and a static elimination device, and the above electrophotographic photoreceptor.

An image forming apparatus according to the present invention includes an image carrier, a charging device that charges a surface of the image carrier, an exposure device that exposes the charged surface of the image carrier to form an electrostatic latent image on the surface of the image carrier, a development device that supplies a toner to the surface of the image carrier to develop the electrostatic latent image as a toner image, and a transfer device that transfers the toner image from the image carrier onto a to-be-transferred body. The image carrier is the above electrophotographic photoreceptor.

### Advantageous Effects of Invention

An electrophotographic photoreceptor, process cartridge, and image forming apparatus according to the present invention is capable of suppressing the overshoot of the charging potential even in the case where the protective layer includes a photocurable resin and has excellent wear resistance.

### BRIEF DESCRIPTION OF THE DRAWINGS

FIG. 1 is a partial cross-sectional view of a single-layer electrophotographic photoreceptor that is an example of the electrophotographic photoreceptor according to a first embodiment of the present invention.

FIG. 2 is a partial cross-sectional view of a single-layer electrophotographic photoreceptor that is an example of the electrophotographic photoreceptor according to the first embodiment of the present invention.

FIG. 3 is a partial cross-sectional view of a stacked electrophotographic photoreceptor that is an example of the electrophotographic photoreceptor according to the first embodiment of the present invention.

FIG. 4 is a partial cross-sectional view of a stacked electrophotographic photoreceptor that is an example of the electrophotographic photoreceptor according to the first embodiment of the present invention.

FIG. 5 is a partial cross-sectional view of a stacked electrophotographic photoreceptor that is an example of the electrophotographic photoreceptor according to the first embodiment of the present invention.

FIG. 6 shows an absorption spectrum of a measurement target that includes a hole transporting agent (HTM-2) before and after predetermined ultraviolet rays are applied, which is measured by ultraviolet-visible spectroscopy.

FIG. 7 is a diagram showing an example of an image forming apparatus according to a second embodiment of the present invention.

FIG. 8 is a diagram showing an example of a configuration of a development device shown in FIG. 7.

### DETAILED DESCRIPTION OF THE EXEMPLARY EMBODIMENTS

Hereinafter, embodiments of the present invention will be described in detail. However, the present invention is not limited to the following embodiments and can be implemented with appropriate modifications within the scope of the present invention.

Acrylic and methacrylic are collectively referred to as “(meth)acrylic” in some cases. Acrylate and methacrylate are collectively referred to as “(meth)acrylate” in some cases. Acryloyl and methacryloyl are collectively referred to as “(meth)acryloyl” in some cases. Unless otherwise specified, the viscosity average molecular weight is a value measured in accordance with JIS (Japanese Industrial Standard) K7252-1:2016. Unless otherwise specified, the hydroxyl value is a value measured in accordance with “JIS (Japanese Industrial Standard) K0070-1992”. Unless otherwise specified, the number average primary particle size is a number average value of an equivalent circle diameter (Heywood diameter: diameter of a circle having the same area as the projected area of a primary particle) of a primary particle measured using a scanning electron microscope. The number average primary particle size is, for example, a number average value of equivalent circle diameters of 100 primary particles. Unless otherwise specified, the BET specific surface area is a value measured by a BET method using nitrogen adsorption in accordance with “JIS (Japanese Industrial Standard) Z8830:2001 Determination of the specific surface area of powders (solids) by gas adsorption-BET method”. The term “-based” is added after the compound name to collectively refer to the compound and derivatives thereof in some cases. Further, in the case of adding the term “-based” after a compound to refer to a polymer name, it means that the repeating unit of the polymer is derived from the compound or a derivative thereof. Further, a “general formula” and a “chemical formula” are collectively referred to as a “formula”. The phrase “each independently” in the description of the formula means that they may indicate the same group or different groups. Unless otherwise specified, the components described in the present specification may each be used alone, or two or more of them may be used in combination. Further, for example, the phrase “at least one type of A, B, and C” means “at least one selected from the group consisting of A, B, and C”. Note that A, B, and C are merely examples and can be replaced with other terms.

### First Embodiment: Electrophotographic Photoreceptor

A first embodiment of the present invention relates to an electrophotographic photoreceptor (hereinafter, referred to as a photoreceptor in some cases). The photoreceptor according to the first embodiment includes a conductive substrate, a photosensitive layer, and a protective layer. The protective layer is a top surface layer of the photoreceptor and includes a photocurable resin. The photosensitive layer includes a charge generating agent and a hole transporting agent. The hole transporting agent includes a compound that has a molecular weight of 580 or more and is represented by a formula (1), (2), (3), or (4). Hereinafter, the “compound that has a molecular weight of 580 or more and is represented by a formula (1), (2), (3), or (4)” will be referred to as a predetermined hole transporting agent in some cases.

By having the above configuration, the photoreceptor according to the first embodiment is capable of suppressing the overshoot of the charging potential even in the case where the protective layer includes a photocurable resin and has excellent wear resistance. The reasons for this are presumed to be as follows.

The overshoot of the charging potential is a phenomenon in which the charging potential excessively rises when the photoreceptor is started to be charged by the charging device and then the charging potential excessively decreases in reaction to that. In image formation, charging of the photoreceptor and elimination of static electricity by static elimination light are repeated. If holes remain in the photosensitive layer due to a delay in the movement of holes in the photosensitive layer during the period from elimination of static electricity of the photoreceptor to the next round of charging of the photoreceptor, the charging potential of the photoreceptor decreases below a desired value in the next round of charging of the photoreceptor. Then, an overshoot of the charging potential occurs.

The overshoot of a charging potential tends to occur particularly in the case where the protective layer includes a photocurable resin. In an example of a protective layer forming step, ultraviolet rays are applied to a coating liquid for forming a protective layer applied onto the photosensitive layer (hereinafter, referred to as a coating liquid for a protective layer in some cases). At least part of the applied ultraviolet rays passes through the coating liquid for a protective layer to reach the photosensitive layer. The reached ultraviolet rays decomposes a general hole transporting agent in some cases. If the hole transporting agent is decomposed, the movement of holes in the photosensitive layer is delayed and holes are likely to remain in the photosensitive layer during the period from elimination of static electricity of the photoreceptor to the next round of charging of the photoreceptor, and an overshoot of the charging potential is likely to occur.

Here, in the first embodiment, the photosensitive layer includes a predetermined hole transporting agent. The predetermined hole transporting agent is a large compound having a molecular weight of 580, and thus has high charge mobility. Further, the predetermined hole transporting agent has a structure represented by the above formulae (1) to (4), and thus is difficult to decompose by ultraviolet rays.

In the case where the photoreceptor is a negatively charged photoreceptor, holes move in the photosensitive layer toward the surface of the photoreceptor. When the photosensitive layer includes a predetermined hole transporting agent, holes move in the photosensitive layer quickly, which makes it difficult for holes to remain in the photosensitive layer after elimination of static electricity. This prevents electrons given to the surface of the photoreceptor during the next round of charging from being canceled out by the remaining holes. As a result, it is possible to charge the photoreceptor to a desired charging potential in the next round and suppress the overshoot of the charging potential.

Further, in the case where the photoreceptor is a positively charged photoreceptor, holes and electrons move in the photosensitive layer. If the movement of holes is delayed, the movement of electrons also tends to be delayed. When the photosensitive layer includes a predetermined hole transporting agent, holes move quickly in the photosensitive layer, and as a result, electrons also move quickly. This causes electrons to move quickly in the photosensitive layer toward the surface of the photoreceptor. For this reason, electrons are difficult to remain in the photosensitive layer after elimination static electricity, and it is possible to prevent holes given to the surface of the photoreceptor from being cancelled out by the remaining electrons during the next round of charging. As a result, it is possible to charge the photoreceptor to a desired charging potential in the next round and suppress the overshoot of the charging potential.

Further, the photoreceptor according to the first embodiment has excellent wear resistance because it includes a protective layer including a photocurable resin.

The reason why the photoreceptor according to the first embodiment suppresses the overshoot of the charging potential and has excellent wear resistance has been described above. The photoreceptor will be further described below.

The photoreceptor is, for example, a single-layer electrophotographic photoreceptor (hereinafter, referred to as a single-layer photoreceptor in some cases) or a stacked electrophotographic photoreceptor (hereinafter, referred to as a stacked photoreceptor in some cases).

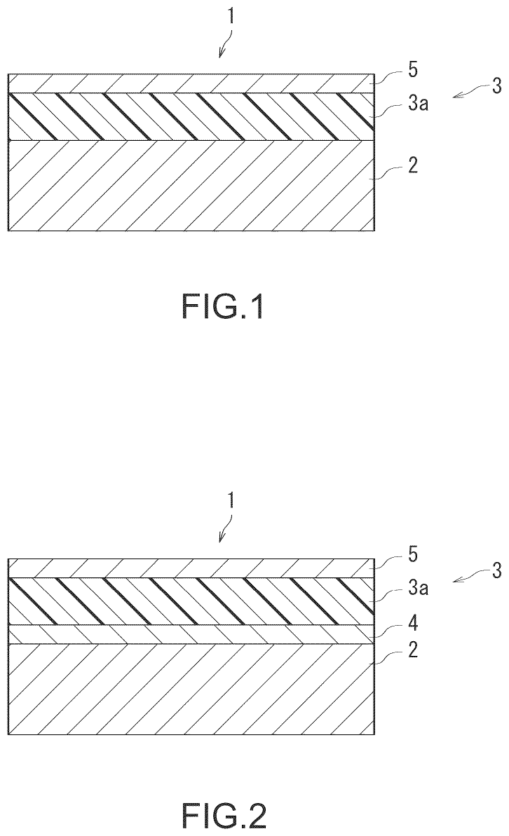

A structure of a single-layer photoreceptor 1 that is an example of a photoreceptor will be described below with reference to FIG. 1 and FIG. 2. FIG. 1 and FIG. 2 are each a partial cross-sectional view of the single-layer photoreceptor 1. As shown in FIG. 1, the single-layer photoreceptor 1 includes, for example, a conductive substrate 2, a photosensitive layer 3, and a protective layer 5. The photosensitive layer 3 is a single-layer photosensitive layer (hereinafter, referred to as a single-layer photosensitive layer in some cases) 3a. In the example shown in FIG. 1, the single-layer photosensitive layer 3a is provided on the conductive substrate 2 and the protective layer 5 is provided on the single-layer photosensitive layer 3a. The single-layer photosensitive layer 3a is provided directly on the conductive substrate 2. The protective layer 5 is the top surface layer of the single-layer photoreceptor 1.

As shown in FIG. 2, the single-layer photoreceptor 1 may further include an intermediate layer 4 (undercoat layer), in addition to the conductive substrate 2, the single-layer photosensitive layer 3a, and the protective layer 5. In the example shown in FIG. 2, the intermediate layer 4 is provided on the conductive substrate 2, the single-layer photosensitive layer 3a is provided on the intermediate layer 4, and the protective layer 5 is provided on the single-layer photosensitive layer 3a. The single-layer photosensitive layer 3a is provided above the conductive substrate 2 via the intermediate layer 4.

The thickness of the single-layer photosensitive layer 3a is not particularly limited, but is favorably 5 μm or more and 100 μm or less, more favorably 10 μm or more and 50 μm or less.

The thickness of the protective layer 5 is not particularly limited, but is favorably 0.1 μm or more and 30.0 μm or less, more favorably 0.3 μm or more and 10.0 μm or less, and still more favorably 0.5 μm or more and 2.0 μm or less. In the examples shown in FIG. 1 and FIG. 2, the protective layer 5 is one layer. However, the protective layer 5 may include a plurality of layers. In the case where the protective layer 5 includes a plurality of layers, at least the top surface layer, of the plurality of layers, includes a photocurable resin. The structure of the single-layer photoreceptor 1 that is an example of a photoreceptor has been described above with reference to FIG. 1 and FIG. 2.

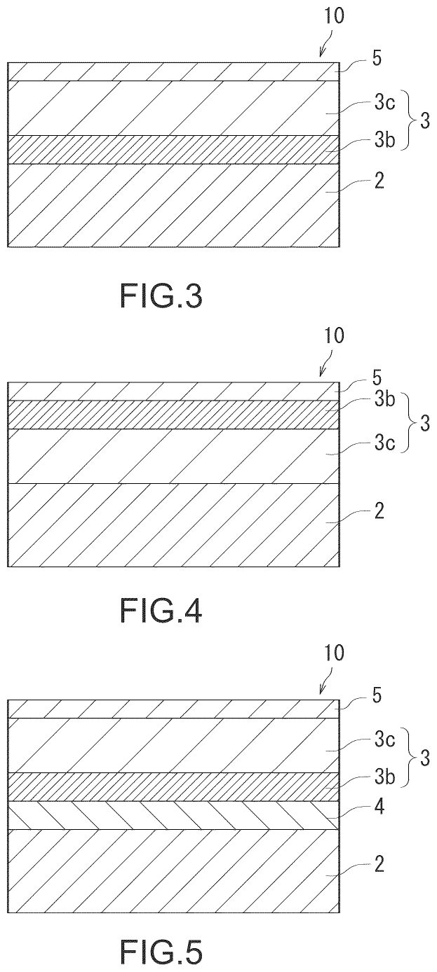

A structure of a stacked photoreceptor 10 that is an example of a photoreceptor will be described below with reference to FIG. 3 to FIG. 5. FIG. 3 to FIG. 5 are each a partial cross-sectional view of the stacked photoreceptor 10. As shown in FIG. 3, the stacked photoreceptor 10 includes, for example, the conductive substrate 2, the photosensitive layer 3, and the protective layer 5. The photosensitive layer 3 includes a charge generating layer 3b and a charge transporting layer 3c. In the example shown in FIG. 3, the charge generating layer 3b is provided on the conductive substrate 2, the charge transporting layer 3c is provided on the charge generating layer 3b, and the protective layer 5 is provided on the charge transporting layer 3c. However, as shown in FIG. 4, in the stacked photoreceptor 10, the charge transporting layer 3c may be provided on the conductive substrate 2, the charge generating layer 3b may be provided on the charge transporting layer 3c, and the protective layer 5 may be provided on the charge generating layer 3b. In the examples shown in FIG. 3 and FIG. 4, the photosensitive layer 3 is provided directly on the conductive substrate 2. The protective layer 5 is the top surface layer of the stacked photoreceptor 10.

As shown in FIG. 5, the stacked photoreceptor 10 may further include the intermediate layer 4 (undercoat layer), in addition to the conductive substrate 2, the photosensitive layer 3, and the protective layer 5. In the example shown in FIG. 5, the intermediate layer 4 is provided on the conductive substrate 2, the charge generating layer 3b is provided on the intermediate layer 4, the charge transporting layer 3c is provided on the charge generating layer 3b, and the protective layer 5 is provided on the charge transporting layer 3c. The photosensitive layer 3 (e.g., the charge generating layer 3b) is provided above the conductive substrate 2 via the intermediate layer 4.

The thickness of the charge generating layer 3b is not particularly limited, but is favorably 0.01 μm or more and 5 μm or less, more favorably 0.1 μm or more and 3 μm or less. In the examples shown in FIG. 3 to FIG. 5, the charge generating layer 3b is one layer. However, the charge generating layer 3b may include a plurality of layers.

The thickness of the charge transporting layer 3c is not particularly limited, but is favorably 2 μm or more and 100 μm or less, more favorably 5 μm or more and 50 μm or less. In the examples shown in FIG. 3 to FIG. 5, the charge transporting layer 3c is one layer. However, the charge transporting layer 3c may include a plurality of layers.

Since the protective layer 5 included in the stacked photoreceptor 10 is similar to the protective layer 5 included in the single-layer photoreceptor 1, description thereof is omitted. The structure of the stacked photoreceptor 10 that is an example of a photoreceptor has been described above with reference to FIG. 3 to FIG. 5.

### <Protective Layer>

The protective layer includes, for example, a photocurable resin and a metal oxide. The protective layer may further include, as necessary, one or both of a polymerization initiator and an additive.

### (Photocurable Resin)

Examples of the photocurable resin include a (meth)acrylic resin and an epoxy resin. In the protective layer forming step described below, the (meth)acrylic resin is favorable as a photocurable resin because the photocuring reaction stops when irradiation of ultraviolet rays is stopped, and the progress of the photocuring reaction can be easily controlled.

The photocurable resin favorably includes a repeating unit derived from a compound having two or more polymerizable functional groups. Hereinafter, the “repeating unit derived from a compound having two or more polymerizable functional groups” will be referred to as a “multifunctional group unit” and the “compound having two or more polymerizable functional groups” will be referred to as a “multifunctional group monomer” in some cases. Since the multifunctional group monomer has two or more polymerizable functional groups, a photocuring reaction in which a polymerizable functional group reacts suitably progresses in the protective layer forming step in the production of a photoreceptor. As a result, the hardness of the protective layer increases, and the wear resistance of the photoreceptor is improved.

Examples of the polymerizable functional group of the multifunctional group unit include a vinyl group and an epoxy group. In the case where the photocurable resin is a (meth)acrylic resin, the (meth)acrylic resin has a vinyl group as a polymerizable functional group. In the case where the photocurable resin has an epoxy resin, the epoxy resin has an epoxy group as a polymerizable functional group.

In the case where the protective layer includes a photocurable resin and the photocurable resin includes a repeating unit derived from a compound having two or more vinyl groups (i.e., a multifunctional group unit having a vinyl group as a polymerizable functional group), ultraviolet rays suitable for cleaving a carbon-carbon double bond of the vinyl group are applied to the coating liquid for a protective layer in the protective layer forming step. Part of the applied ultraviolet rays passes through the coating liquid for a protective layer to reach the photosensitive layer. The ultraviolet rays that have reached the photosensitive layer cleave part of the carbon-carbon double bond of the hole transporting agent included in the photosensitive layer to decompose the hole transporting agent in some cases. However, as described above, the predetermined hole transporting agent is difficult to decompose by ultraviolet rays. Therefore, even in the case where the photocurable resin includes a repeating unit derived from a compound having two or more vinyl groups, the predetermined hole transporting agent in the photosensitive layer is difficult to decompose. As a result, the sensitivity characteristics of the photoreceptor are improved, and the overshoot of the charging potential is suppressed.

The multifunctional group unit is a favorably a repeating unit derived from a compound having 2 or more and 10 or less polymerizable functional groups, more favorably a repeating unit derived from a compound having 3 or more and 6 or less polymerizable functional groups.

Examples of the multifunctional group monomer for forming a multifunctional group unit include a trimethylolpropane triacrylate, a glycerin triacrylate, a tris-(2-acryloxyethyl)isocyanurate, a pentaerythritol triacrylate, a pentaerythritol tetraacrylate, a ditrimethylolpropane tetraacrylate, a dipentaerythritol pentaacrylate, and a dipentaerythritol hexaacrylate. These multifunctional group monomers may be ethoxylated.

The multifunctional group monomer is favorably at least one selected from the group consisting of a pentaerythritol triacrylate, a pentaerythritol tetraacrylate, a dipentaerythritol pentaacrylate, and a dipentaerythritol hexaacrylate, more favorably one or two of them.

The above pentaerythritol triacrylate, pentaerythritol tetraacrylate, dipentaerythritol pentaacrylate, and dipentaerythritol hexaacrylate are respectively compounds represented by the following formulae (EA-1), (EA-2), (EA-3), and (EA-4). Therefore, the multifunctional group unit is favorably a repeating unit derived from at least one selected from the group consisting of the compounds represented by the formulae (EA-1), (EA-2), (EA-3), and (EA-4), more favorably a repeating unit derived from one or two of them. The multifunctional group unit is still more favorably a repeating unit derived from at least one selected from the group consisting of the compounds represented by the formulae (EA-1) and (EA-2).

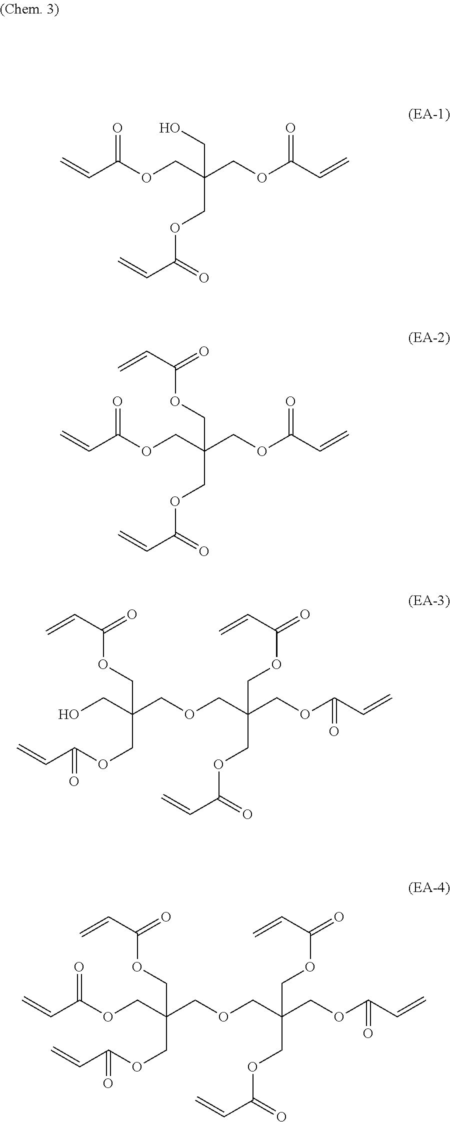

A multifunctional group unit is formed by polymerizing the polymerizable functional group of the multifunctional group monomer. For example, repeating units represented by formulae (EA-1a), (EA-2a), (EA-3a), and (EA-4a), which are multifunctional group units, are respectively formed from the compounds represented by the formulae (EA-1), (EA-2), (EA-3), and (EA-4), which are multifunctional group monomers, by the photocuring reaction (more specifically, an addition polymerization reaction of a vinyl group).

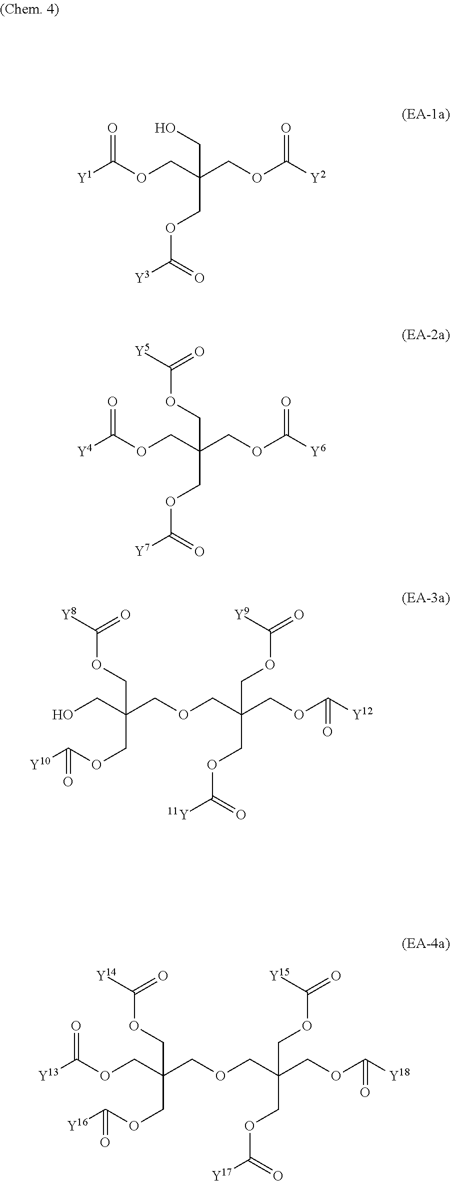

At least one of Y¹ to Y³ in the formula (EA-1a) represents a group represented by the formula (Y-b), and the remainder(s) of the at least one of Y¹ to Y³ represent(s) a group represented by the formula (Y-a). At least one of Y⁴ to Y⁷ in the formula (EA-2a) represents a group represented by the formula (Y-b), and the remainder(s) of the at least one of Y⁴ to Y⁷ represent(s) a group represented by the formula (Y-a). At least one of Y⁸ to Y¹² in the formula (EA-3a) represents a group represented by the formula (Y-b), and the remainder(s) of the at least one of Y⁸ to Y¹² represent(s) a group represented by the formula (Y-a). At least one of Y¹³ to Y¹⁸ in the formula (EA-3a) represents a group represented by the formula (Y-b), and the remainder(s) of the at least one of Y¹³ to Y⁸ represent(s) a group represented by the formula (Y-a).

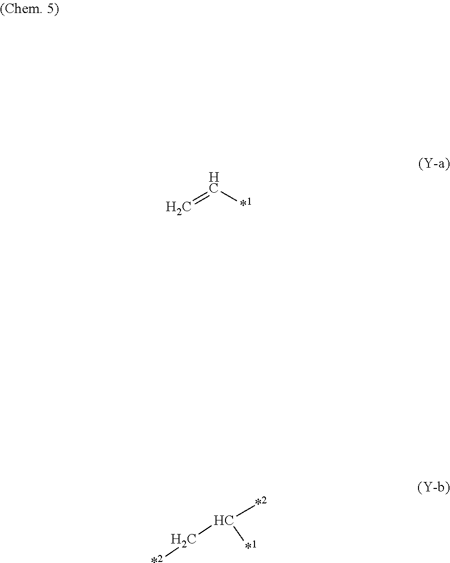

*¹ in the formulae (Y-a) and (Y-b) represents atomic bonding to be bonded to a carbon atom of a carbonyl group in the formulae (EA-1a) to (EA-4a). *² in the formula (Y-b) represents atomic bonding to be bonded to another repeating unit.

The double bond of the group represented by the formula (Y-a) is cleaved by the photocuring reaction (more specifically, an addition polymerization reaction of a vinyl group) to form the group represented by the formula (Y-b). Therefore, as the photocuring reaction (more specifically, an addition polymerization reaction of a vinyl group) progresses, the group represented by the formula (Y-a) decreases and the group represented by the formula (Y-b) increases.

The multifunctional group monomer is favorably a mixture of a pentaerythritol triacrylate and a pentaerythritol tetraacrylate. The content ratio of the pentaerythritol triacrylate occupied in the mixture of the pentaerythritol triacrylate and the pentaerythritol tetraacrylate is favorably 40 mass % or more and 60% or less. The multifunctional group monomer is favorably a mixture of a dipentaerythritol pentaacrylate and a dipentaerythritol hexaacrylate.

The hydroxyl value of the multifunctional group monomer is favorably 1 mgKOH/g or more and 50 mgKOH/g or less, more favorably 5 mgKOH/g or more and 15 mgKOH/g or less.

The photocurable resin may include only a multifunctional group unit or may further include a repeating unit derived from a compound having one polymerizable functional group (monofunctional group unit), in addition to the multifunctional group unit. The content ratio of the multifunctional group unit occupied in the total number of the repeating units in the photocurable resin is favorably 80 mass % or more, more favorably 90 mass % or more, and still more favorably 100 mass %. Further, the photocurable resin may include one type of multifunctional group unit or two or more types (e.g., two types or three types) of multifunctional group units.

The content ratio of the photocurable resin occupied in the protective layer is favorably 50 mass % or more and 99 mass % or less, more favorably 70 mass % or more and 90 mass % or less, with respect to the mass of the protective layer.

### (Metal Oxide)

Examples of the metal oxide include alumina, zinc oxide, titanium oxide, and tin oxide. The metal oxide does not necessarily need to be doped. However, in order to increase the conductivity of the protective layer, the metal oxide is favorably doped. Examples of the doped metal oxide include phosphorus-doped tin oxide and antimony-doped tin oxide. As the metal oxide, tin oxide is favorable, and phosphorus-doped tin oxide or antimony-doped tin oxide is more favorable. The metal oxide is included in, for example, the protective layer as a metal oxide particle.

The BET specific surface area of the metal oxide particle is favorably 30 m²/g or more and 200 m²/g or less, more favorably 55 m²/g or more and 130 m²/g or less. The number average primary particle size of the metal oxide particle is favorably 5 nm or more and 50 nm or less, more favorably 20 nm or more and 35 nm or less.

The content ratio of the metal oxide occupied in the protective layer is favorably 1 mass % or more and 20 mass % or less, more favorably 5 mass % or more and 15 mass % or less, with respect to the mass of the protective layer.

### (Polymerization Initiator)

The polymerization initiator is, for example, a photopolymerization initiator. Examples of the photopolymerization initiator include an acylphosphine oxide compound, an acetophenone compound, a ketal compound, a benzoinether compound, an anthraquinone compound, and a thioxanthone compound. An acylphosphine oxide compound is favorable as a photopolymerization initiator because it has high ultraviolet absorption efficiency. Examples of the acylphosphine oxide compound include 2,4,6-trimethylbenzoyl-diphenylphosphineoxide, phenylbis(2,4,6-trimethylbenzoyl)phosphineoxide, and lithiumphenyl(2,4,6-trimethylbenzoyl)phosphonate. The content ratio of the polymerization initiator occupied in the protective layer is favorably 1 mass % or more and 20 mass % or less, more favorably 5 mass % or more and 10 mass % or less, with respect to the mass of the protective layer.

### (Additive)

Examples of the additive included in the protective layer include a leveling agent (e.g., a UV curable fluorosilicone modified acrylic polymer) and silica. Note that it is favorable that the protective layer does not include a charge generating agent, a hole transporting agent, and an electron transporting agent.

### <Photosensitive Layer>

The photosensitive layer includes a charge generating agent, a hole transporting agent, and a binder resin. In the case where the photoreceptor is a single-layer photoreceptor, the single-layer photosensitive layer that is a photosensitive layer includes, for example, a charge generating agent, a hole transporting agent, a binder resin, and an electron transporting agent. The single-layer photosensitive layer may further include an additive, as necessary.

In the case where the photoreceptor is a stacked photoreceptor, the charge generating layer included in the photosensitive layer includes, for example, a charge generating agent and a base resin. The charge transporting layer included in the photosensitive layer includes, for example, a hole transporting agent and a binder resin. Each of the charge generating layer and the charge transporting layer may further include an additive, as necessary. Note that since the hole transporting agent used in the photoreceptor according to the first embodiment is hard to decompose by ultraviolet rays, each of the charge generating layer and the charge transporting layer does not necessarily need to include a radical acceptor compound.

### (Charge Generating Agent)

Examples of the charge generating agent include a phthalocyanine pigment, a perylene pigment, a bisazo pigment, a trisazo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, a powder of inorganic photoconductive materials (e.g., selenium, selenium-tellurium, selenium-arsenic, cadmium sulfide, and amorphous silicon), a pyrylium pigment, an anthanthron pigment, a triphenylmethane pigment, a threne pigment, a toluidine pigment, a pyrazoline pigment, and a quinacridone pigment.

The phthalocyanine pigment has a phthalocyanine structure. Examples of the phthalocyanine pigment include metal phthalocyanine and metal-free phthalocyanine. Examples of the metal phthalocyanine include titanyl phthalocyanine, hydroxygallium phthalocyanine, and chlorogallium phthalocyanine. As the metal phthalocyanine, titanyl phthalocyanine is favorable. The titanyl phthalocyanine is represented by the formula (CG-1). The metal-free phthalocyanine is represented by the formula (CG-2).

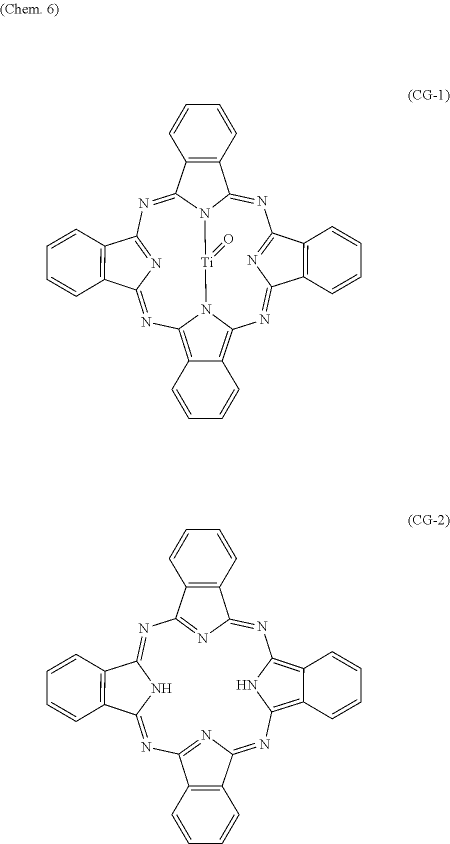

The phthalocyanine pigment may be crystalline or non-crystalline. Examples of the crystal of the metal-free phthalocyanine include an X-type crystal of the metal-free phthalocyanine (hereinafter, referred to as an X-type metal-free phthalocyanine in some cases). Examples of the crystal of the titanyl phthalocyanine include α-type, β-type, and Y-type crystals of the titanyl phthalocyanine (hereinafter, respectively referred to as α-type, β-type, and Y-type titanyl phthalocyanines in some cases).

For example, for a digital optical image forming apparatus (e.g., a laser beam printer or a facsimile machine using a light source such as semiconductor laser light), it is favorable to use a photoreceptor having sensitivity in a wavelength region of 700 nm or more. As the charge generating agent, a phthalocyanine pigment is favorable, titanyl phthalocyanine or metal-free phthalocyanine is more favorable, and Y-type titanyl phthalocyanine or X-type metal-free phthalocyanine is particularly favorable because they have a high quantum yield in the wavelength region of 700 nm or more.

The Y-type titanyl phthalocyanine has a main peak at, for example, 27.2° of the Bragg angle (2θ±0.2°) in the CuKα characteristic X-ray diffraction spectrum. The main peak in the CuKα characteristic X-ray diffraction spectrum is a peak having the first or second highest intensity in the range of the Bragg angle (2θ±0.2°) of 3° or more and 400 or less. The Y-type titanyl phthalocyanine does not have a peak at 26.2° in the CuKα characteristic X-ray diffraction spectrum.

The CuKα characteristic X-ray diffraction spectrum can be measured by, for example, the following method. First, a sample holder of an X-ray diffractometer (e.g., “RINT (registered trademark) 1100” manufactured by Rigaku Holdings Corporation and its Global Subsidiaries) is filled with a sample (titanyl phthalocyanine) to measure the X-ray diffraction spectrum under the conditions of an X-ray tube Cu, a tube voltage of 40 kV, a tube current of 30 mA, and a wavelength of CuKα characteristic X-rays of 1.542 Å. The measurement range (2θ) is, for example, 3° or more and 400 or less (start angle of 3°, stop angle of 40°), and the scanning speed is, for example, 10°/min. The main peak is determined from the obtained X-ray diffraction spectrum, and the Bragg angle of the main peak is read.

In the case where the photoreceptor is a single-layer photoreceptor, the content of the charge generating agent in the single-layer photosensitive layer that is a photosensitive layer is favorably 0.1 parts by mass or more and 50 parts by mass or less, more favorably 0.5 parts by mass or more and 30 parts by mass or less, with respect to 100 parts by mass of the binder resin. In the case where the photoreceptor is a stacked photoreceptor, the content of the charge generating agent in the photosensitive layer (specifically, the charge generating layer) is favorably 10 parts by mass or more and 300 parts by mass or less, more favorably 100 parts by mass or more and 200 parts by mass or less, with respect to 100 parts by mass of the base resin.

### (Hole Transporting Agent)

The hole transporting agent includes a predetermined hole transporting agent. In the present specification, the compound that has a molecular weight of 580 or more and is represented by a formula (1), (2), (3), or (4) refers to a compound having a molecular weight of 580 or more, of the compounds represented by the formulae (1), (2), (3), and (4).

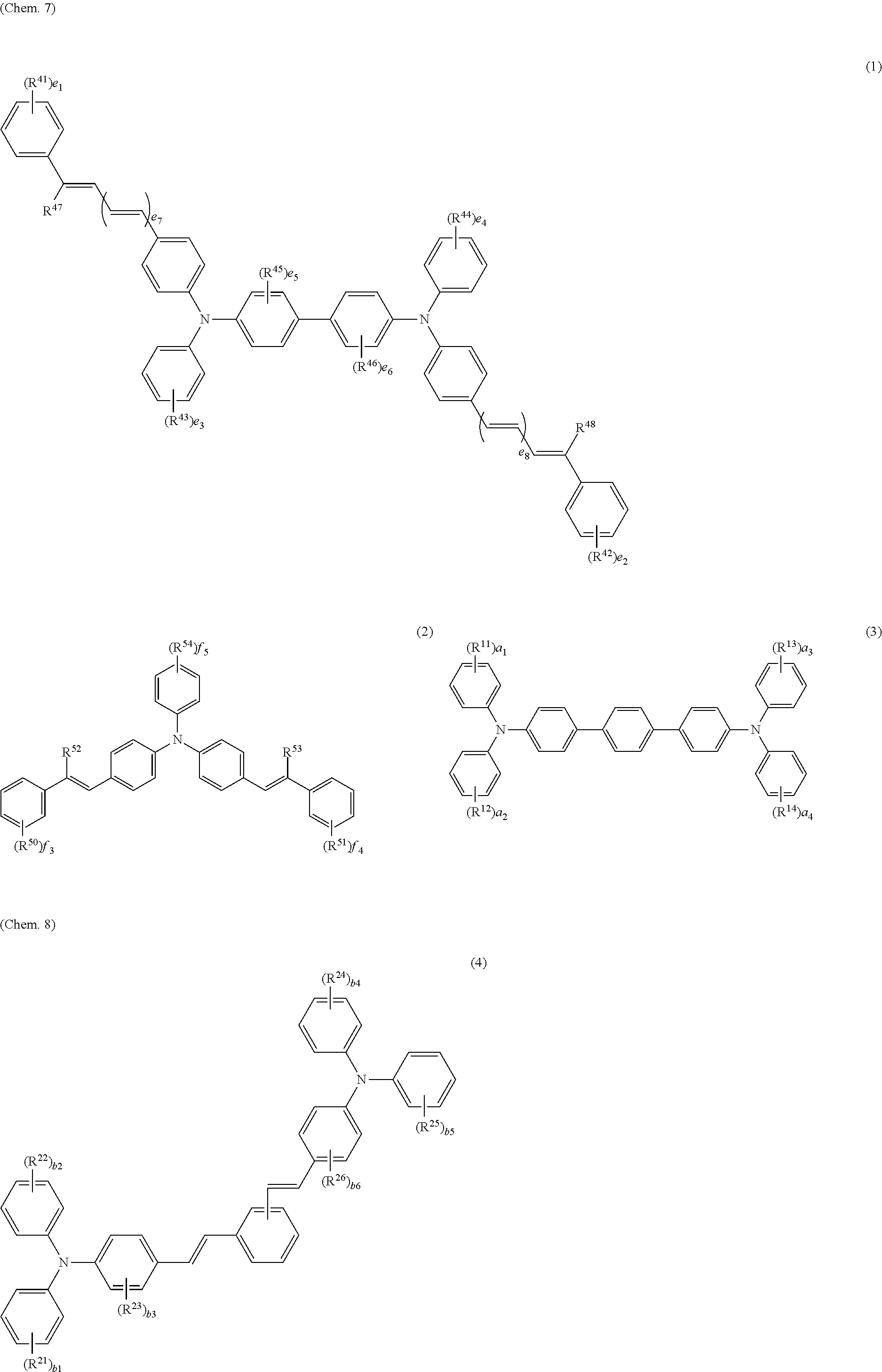

In the formula (1), R⁴¹, R⁴², R⁴³, R⁴⁴, R⁴⁵, and R⁴⁶ each independently represent an alkyl group having 1 or more and 8 or less carbon atoms or a phenyl group. R⁴⁷ and R⁴⁸ each independently represent a hydrogen atom, an alkyl group having 1 or more and 8 or less carbon atoms, or a phenyl group. e₁, e₂, e₃, and e₄ each independently represent an integer of 0 or more and 5 or less. e₅ and e₆ each independently represent an integer of 0 or more and 4 or less. e₇ and es each independently represent 0 or 1.

In the formula (1), when e₁ represents an integer of 2 or more and 5 or less, a plurality of R⁴¹ may represent the same group or different groups. When e₂ represents an integer of 2 or more and 5 or less, a plurality of R⁴² may represent the same group or different groups. When e₃ represents an integer of 2 or more and 5 or less, a plurality of R⁴³ may represent the same group or different groups. When e₄ represents an integer of 2 or more and 5 or less, a plurality of R⁴⁴ may represent the same group or different groups. When e₅ represents an integer of 2 or more and 4 or less, a plurality of R⁴⁵ may represent the same group or different groups. When e₆ represents an integer of 2 or more and 4 or less, a plurality of R⁴⁶ may represent the same group or different groups.

In the formula (1), R⁴¹ to R⁴⁶ each independently represent favorably an alkyl group having 1 or more and 8 or less carbon atoms, more favorably an alkyl group having 1 or more and 3 or less carbon atoms, and still more favorably a methyl group or an ethyl group. R⁴⁷ and R⁴⁸ favorably each represent a hydrogen atom. It is favorable that e₁, e₂, e₃, and e₄ each independently represent an integer of 0 or more and 2 or less, and it is more favorable that e₁ and e₂ each represent 0 and e₃ and e₄ each represent 2. e₅ and e₆ favorably each represent 0. In order to further suppress decomposition of the hole transporting agent by ultraviolet rays, e₇ and es favorably each represent 0.

In the formula (2), R⁵⁰, R⁵¹, and R⁵⁴ each independently represent an alkyl group having 1 or more and 8 or less carbon atoms or a phenyl group. R⁵² and R⁵³ each independently represent a hydrogen atom, an alkyl group having 1 or more and 8 or less carbon atoms, or a phenyl group that may be substituted with an alkyl group having 1 or more and 8 or less carbon atoms. f₃, f₄, and f₅ each independently represent an integer of 0 or more and 5 or less.

In the formula (2), when f₃ represents an integer of 2 or more and 5 or less, a plurality of R⁵⁰ may represent the same group or different groups. When f₄ represents an integer of 2 or more and 5 or less, a plurality of R⁵¹ may represent the same group or different groups. When f₅ represents an integer of 2 or more and 5 or less, a plurality of R⁵⁴ may represent the same group or different groups.

In the formula (2), R⁵⁰, R⁵¹, and R⁵⁴ each independently represent favorably an alkyl group having 1 or more and 8 or less carbon atoms, more favorably an alkyl group having 1 or more and 3 or less carbon atoms, and still more favorably a methyl group. R⁵² and R⁵³ favorably each independently represent a hydrogen atom, an unsubstituted phenyl group, or a phenyl group substituted with an alkyl group having 1 or more and 8 or less carbon atoms. In the case where a phenyl group is substituted with an alkyl group having 1 or more and 8 or less carbon atoms, as such an alkyl group having 1 or more and 8 or less carbon atoms, an alkyl group having 1 or more and 3 or less carbon atoms is favorable and a methyl group is more favorable. f₃, f₄, and f₅ favorably each independently represent 0 or 1.

In the formula (3), R¹¹, R¹², R¹³, and R¹⁴ each independently represent an alkyl group having 1 or more and 8 or less carbon atoms or a phenyl group. a₁, a₂, a₃, and a₄ each independently represent an integer of 0 or more and 5 or less.

In the formula (3), when a₁ represents an integer of 2 or more and 5 or less, a plurality of R¹¹ may represent the same group or different groups. When a₂ represents an integer of 2 or more and 5 or less, a plurality of R¹² may represent the same group or different groups. When a₃ represents an integer of 2 or more and 5 or less, a plurality of R¹³ may represent the same group or different groups. When a₄ represents an integer of 2 or more and 5 or less, a plurality of R¹⁴ may represent the same group or different groups.

In the formula (3), R¹¹, R¹², R¹³, and R¹⁴ each independently represent favorably an alkyl group having 1 or more and 3 or less carbon atoms, more favorably a methyl group or an ethyl group. a₁, a₂, a₃, and a₄ each independently represent favorably an integer of 1 or more and 3 or less, more favorably 1.

In the formula (4), R²¹, R²², R²³, R²⁴, R²⁵, and R²⁶ each independently represent an alkenyl group having 2 or more and 6 or less carbon atoms that may be substituted with at least one phenyl group or an alkyl group having 1 or more and 8 or less carbon atoms. b1, b2, b4, and b5 each independently represent an integer of 0 or more and 5 or less. b3 and b6 each independently represent an integer of 0 or more and 4 or less.

In the formula (4), when b1 represents an integer of 2 or more and 5 or less, a plurality of R²¹ may represent the same group or different groups. When b2 represents an integer of 2 or more and 5 or less, a plurality of R²² may represent the same group or different groups. When b4 represents an integer of 2 or more and 5 or less, a plurality of R²⁴ may represent the same group or different groups. When b5 represents an integer of 2 or more and 5 or less, a plurality of R²⁵ may represent the same group or different groups. When b3 represents an integer of 2 or more and 4 or less, a plurality of R²³ may represent the same group or different groups. When b6 represents an integer of 2 or more and 4 or less, a plurality of R²⁶ may represent the same group or different groups.

In the formula (4), R²¹, R²³, R²⁴, and R²⁶ each independently represent favorably an alkyl group having 1 or more and 8 or less carbon atoms, more favorably an alkyl group having 1 or more and 3 or less carbon atoms, and still more favorably a methyl group or an ethyl group. R²² and R²⁵ each represent favorably an alkenyl group having 2 or more and 6 or less carbon atoms, which may be substituted with at least one phenyl group, favorably an alkenyl group having 2 or more and 4 or less carbon atoms, which may be substituted with at least one phenyl group, more favorably an alkenyl group having 2 or more and 4 or less carbon atoms, which may be substituted with two phenyl groups, and still more favorably a 2,2-diphenylethenyl group. b1, b2, b4, and b5 favorably each independently represent 1 or 2. It is more favorable that b1 and b4 represent 2 and b2 and b5 represent 1. b3 and b6 favorably represent 0. The diphenylaminophenylethenyl group having R²⁴, R²⁵, and R²⁶ is favorably bonded to the para position of the phenyl group relative to the diphenylaminophenylethenyl group having R²¹, R²², and R²³.

Suitable examples of the predetermined hole transporting agent include compounds represented by formulae (HTM-1), (HTM-2), (HTM-3), (HTM-4), (HTM-5), (HTM-6), (HTM-7), and (HTM-8) (hereinafter, respectively referred to as hole transporting agents (HTM-1), (HTM-2), (HTM-3), (HTM-4), (HTM-5), (HTM-6), (HTM-7), and (HTM-8) in some cases).

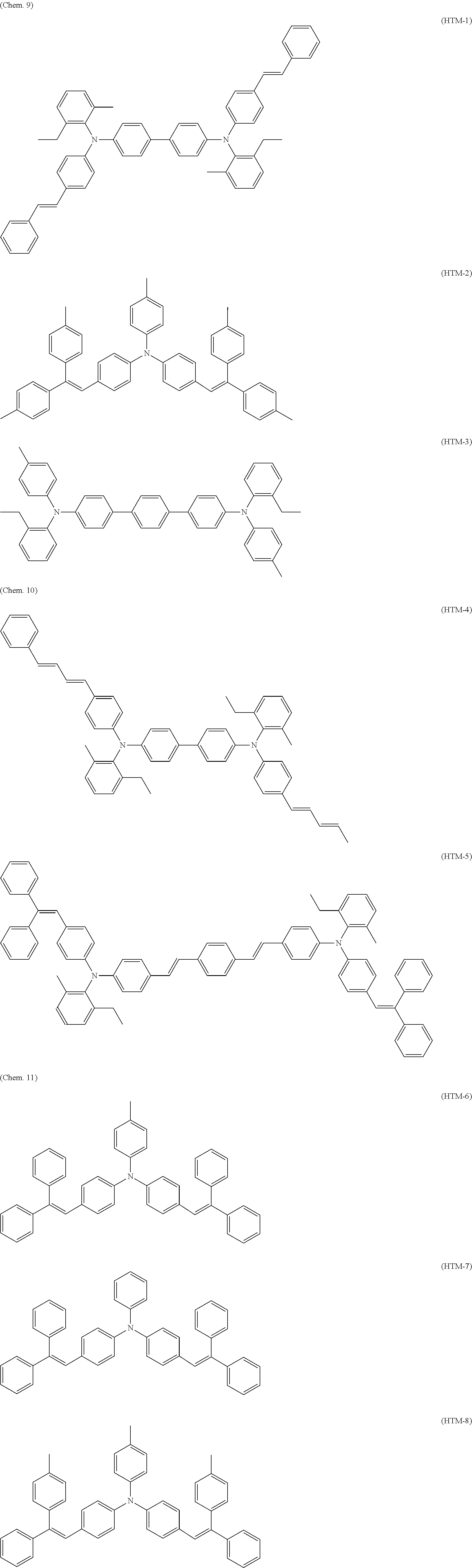

In order to further suppress decomposition of the hole transporting agent by ultraviolet rays, the predetermined hole transporting agent is favorably the hole transporting agent (HTM-1), (HTM-2), or (HTM-3). However, the predetermined hole transporting agent may be, for example, the hole transporting agent (HTM-4), (HTM-5), (HTM-6), (HTM-7), or (HTM-8).

When the residual ratio after irradiation of ultraviolet rays of the predetermined hole transporting agent included in the photosensitive layer is represented by Z, the residual ratio (Z) after irradiation of ultraviolet rays is favorably 75% or more. Hereinafter, the “residual ratio (Z) after irradiation of ultraviolet rays” will be referred to as a “residual ratio Z” in some cases. In the protective layer forming step, ultraviolet rays suitable for progressing the photocuring reaction (e.g., an addition polymerization reaction of a vinyl group) are applied to the coating liquid for a protective layer applied onto the photosensitive layer. At least part of the applied ultraviolet rays passes through the coating liquid for a protective layer to reach the photosensitive layer. The predetermined hole transporting agent having the residual ratio Z of 75% or more is difficult to decompose by ultraviolet rays applied in the protective layer forming step. When the photosensitive layer includes the predetermined hole transporting agent having the residual ratio Z of 75% or more, it is possible to suppress decomposition of the hole transporting agent by ultraviolet rays applied in the protective layer forming step. As a result, it is possible to improve the sensitivity characteristics of the photoreceptor and suppress the overshoot of the charging potential.

The residual ratio Z is calculated by a calculation formula (I).

$$Z = 100 \times ( A 2 / A 1 ) \qquad ( I )$$

In the formula (I), A1 represents absorbance of the measurement target at a wavelength of 365 nm before irradiation of predetermined ultraviolet rays (hereinafter, referred to as absorbance A1 in some cases). A2 represents absorbance of the measurement target at a wavelength of 365 nm after irradiation of predetermined ultraviolet rays (hereinafter, referred to as absorbance A2 in some cases). In the present specification, the predetermined ultraviolet rays is defined as ultraviolet rays of a wavelength of 365 nm and an accumulated light amount of 34200 mW-s. The measurement target is a sheet in which a hole transporting agent is dispersed in a bisphenol Z-type polycarbonate resin. More specifically, the measurement target is a sheet having a thickness of 3 μm in which 33.5 parts by mass of a hole transporting agent is dispersed in 138.0 parts by mass of a bisphenol Z-type polycarbonate resin.

Note that since the bisphenol Z-type polycarbonate resin does not have a chain group including a carbon-carbon double bond, the bisphenol Z-type polycarbonate resin is not substantially decomposed by irradiation of predetermined ultraviolet rays. For this reason, a bisphenol Z-type polycarbonate resin is used as a base material of the measurement target. Further, since the bisphenol Z-type polycarbonate resin is not substantially decomposed by irradiation of predetermined ultraviolet rays, the residual ratio Z of the measurement target is regarded as the residual ratio Z of the hole transporting agent.

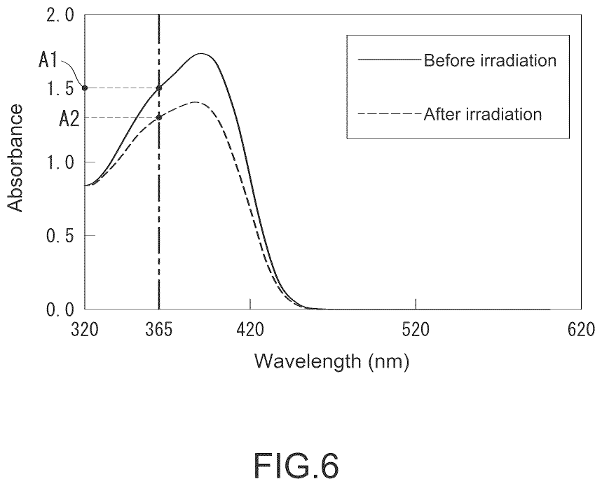

A method of measuring the residual ratio Z of the hole transporting agent will be described below with reference to FIG. 6. FIG. 6 shows an absorption spectrum of the measurement target including the hole transporting agent (HTM-2) described below before and after irradiation of predetermined ultraviolet rays. This absorption spectrum is measured by ultraviolet-visible spectroscopy. The horizontal axis in FIG. 6 indicates a wavelength (unit: nm), and the vertical axis indicates absorbance. The ultraviolet-visible light absorption spectrum of the measurement target before and after applying predetermined ultraviolet rays is measured using an ultraviolet-visible spectrophotometer. The absorbance A1 at a wavelength of 365 nm is obtained from the ultraviolet-visible light absorption spectrum (spectrum indicated by a solid line in FIG. 6) measured before applying predetermined ultraviolet rays. The absorbance A2 at a wavelength of 365 nm is obtained from the ultraviolet-visible light absorption spectrum (spectrum indicated by a broken line in FIG. 6) measured after applying predetermined ultraviolet rays. Then, the residual ratio Z of the hole transporting agent is calculated from the absorbance A1 and the absorbance A2 in accordance with the calculation formula (I). Details of the method of measuring the residual ratio Z of the hole transporting agent will be described below in Examples.

In order to suppress decomposition of the hole transporting agent by ultraviolet rays, improve the sensitivity characteristics of the photoreceptor, and suppress the overshoot of the charging potential, the residual ratio Z of the hole transporting agent is favorably 80% or more, more favorably 85% or more, and still more favorably 90% or more. The residual ratio Z of the hole transporting agent is, for example, 100% or less.

The content ratio of the predetermined hole transporting agent occupied in the hole transporting agent is favorably 80 mass % or more, more favorably 90 mass % or more, and still more favorably 100 mass %, with respect to the total mas of the hole transporting agent. In the case where the photoreceptor is a single-layer photoreceptor, the content of the hole transporting agent in the single-layer photosensitive layer that is a photosensitive layer is favorably 10 parts by mass or more and 200 parts by mass or less, more favorably 30 parts by mass or more and 130 parts by mass or less, with respect to 100 parts by mass of the binder resin. In the case where the photoreceptor is a stacked photoreceptor, the content of the hole transporting agent in the photosensitive layer (specifically, the charge transporting layer) is favorably 10 parts by mass or more and 200 parts by mass or less, more favorably 50 parts by mass or more and 100 parts by mass or less, with respect to 100 parts by mass of the binder resin.

### (Electron Transporting Agent)

Examples of the electron transporting agent include a quinone compound, a diimide compound, a hydrazone compound, a malononitrile compound, a thiopyran compound, a trinitrothioxanthone compound, a 3,4,5,7-tetranitro-9-fluorenone compound, a dinitroanthracene compound, a dinitroacridine compound, tetracyanoethylene, 2,4,8-trinitrothioxanthone, dinitrobenzene, dinitroacridine, succinic anhydride, maleic anhydride, and dibromomaleic anhydride. Examples of the quinone compound include a diphenoquinone compound, an azoquinone compound, an anthraquinone compound, a naphthoquinone compound, a nitroanthraquinone compound, and a dinitroanthraquinone compound.

The electron transporting agent includes favorably at least one of compounds represented by formulae (11), (12), (13), (14), (15), and (16), more favorably at least one (favorably two) of the compounds represented by the formulae (11) and (16). Hereinafter, the compounds represented by the formulae (11), (12), (13), (14), (15), and (16) will be respectively referred to as electron transporting agents (11), (12), (13), (14), (15), and (16) in some cases.

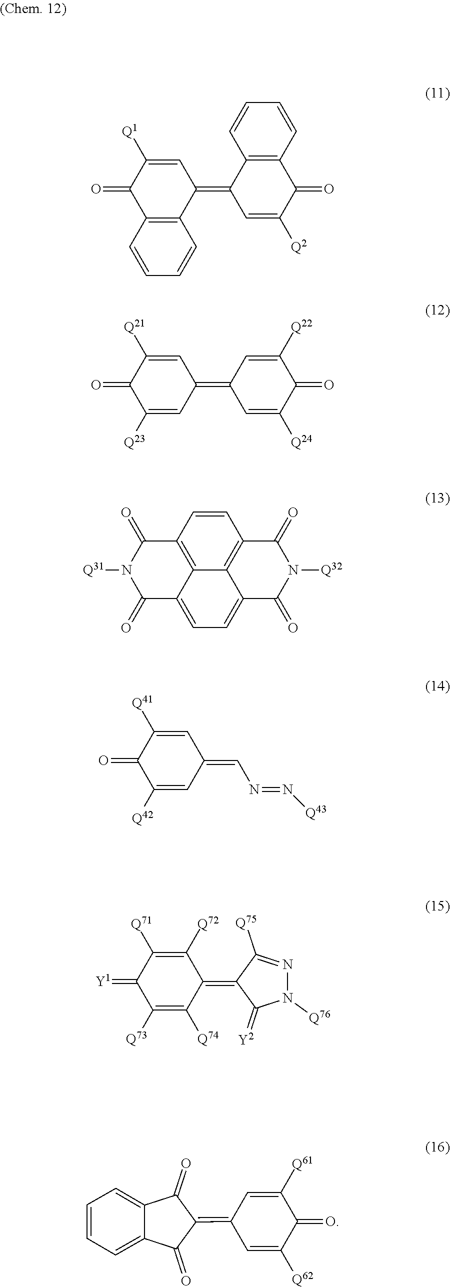

Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms, which may be substituted with at least one substituent group selected from the group consisting of an alkyl group having 1 or more and 6 or less carbon atoms and a halogen atom. Y¹ and Y² in the formula (15) each represent an oxygen atom.

Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16) favorably each independently represent a hydrogen atom, an alkyl group having 1 or more and 6 or less carbon atoms, or an aryl group having 6 or more and 14 or less carbon atoms, which may be substituted with at least one substituent group selected from the group consisting of an alkyl group having 1 or more and 6 or less carbon atoms and a halogen atom.

The alkyl group having 1 or more and 6 or less carbon atoms represented by Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16), an alkyl group having 1 or more and 5 or less carbon atoms is favorable, a methyl group, an ethyl group, a propyl group, a butyl group, or a pentyl group is more favorable, a methyl group, a tert-butyl group, or a 1,1-dimethylpropyl group is particularly favorable.

As the aryl group having 6 or more and 14 or less carbon atoms represented by Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁷¹, Q⁷², Q⁷³, Q⁷⁴, Q⁷⁵, and Q⁷⁶ in the formula (15), and Q⁶¹ and Q⁶² in the formula (16), an aryl group having 6 or more and 10 or less carbon atoms is favorable and a phenyl group is more favorable. The aryl group having 6 or more and 14 or less carbon atoms may be substituted with at least one substituent group selected from the group consisting of an alkyl group having 1 or more and 6 or less carbon atoms and a halogen atom. As such an alkyl group having 1 or more and 6 or less carbon atoms, an alkyl group having 1 or more and 3 or less carbon atoms is favorable and a methyl group or an ethyl group is more favorable. As the halogen atom that is a substituent group, a fluorine atom, a chlorine atom, or a bromine atom is favorable and a chlorine atom is particularly favorable. In the case where the aryl group having 6 or more and 14 or less carbon atoms is substituted with a substituent group, the number of substituent groups is favorably 1 or more and 5 or less, more favorably 1 or 2. As the aryl group having 6 or more and 14 or less carbon atoms substituted with at least one substituent group selected from the group consisting of an alkyl group having 1 or more and 6 or less carbon atoms and a halogen atom, a chlorophenyl group, a dichlorophenyl group, or an ethylmethylphenyl group is favorable and a 4-chlorophenyl group, a 2,5-dichlorophenyl group, or a 2-ethyl-6-methylphenyl group is more favorable.

Suitable examples of the electron transporting agent include compounds represented by formulae (ET-1) to (ET-7) (hereinafter, respectively referred to as electron transporting agents (ET-1) to (ET-7) in some cases). As the electron transporting agent, at least one of the electron transporting agent (ET-1) or (ET-6) is more favorable, and at least two of the electron transporting agent (ET-1) or (ET-6) is still more favorable.

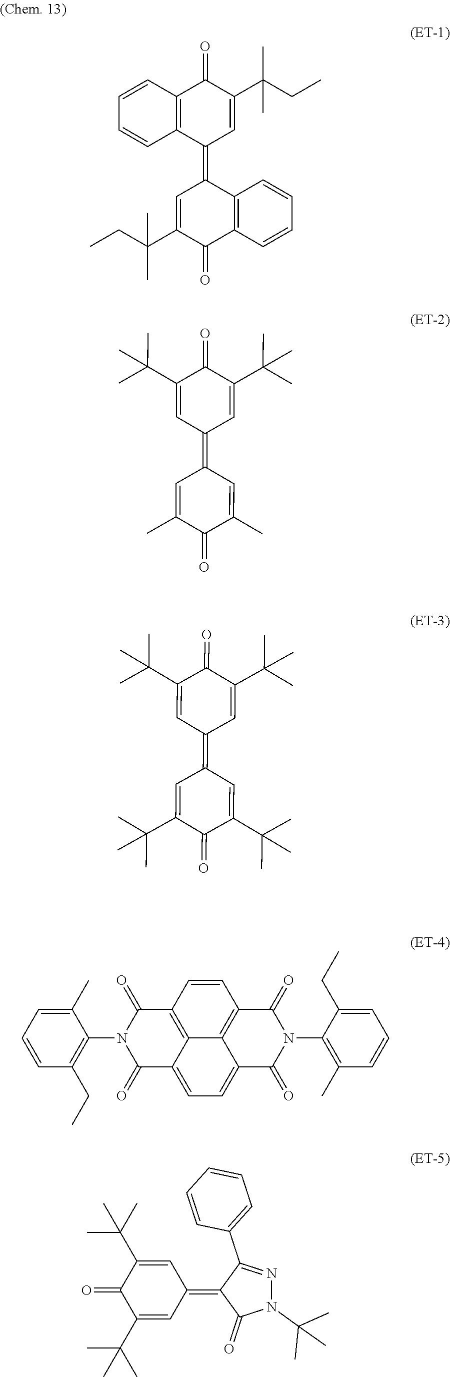

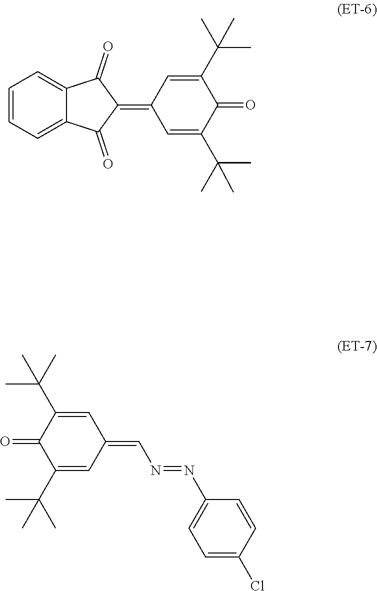

The content ratio of the electron transporting agents (11) to (16) occupied in all electron transporting agents in the photosensitive layer is favorably 80 mass % or more, more favorably 90 mass % or more, and still more favorably 100 mass %, with respect to the total mass of the electron transporting agents in the photosensitive layer. In the case where the photoreceptor is a single-layer photoreceptor, the content of the electron transporting agent in the single-layer photosensitive layer that is a photosensitive layer is favorably 5 parts by mass or more and 150 parts by mass or less, more favorably 30 parts by mass or and 60 parts by mass or less, with respect to 100 parts by mass of the binder resin.

### (Binder Resin)

Examples of the binder resin include a thermoplastic resin (more specifically, a polyarylate resin, a polycarbonate resin, a styrene resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallylphthalate resin, a ketone resin, a polyvinylbutyral resin, a polyvinylacetal resin, and a polyether resin), a thermosetting resin (more specifically, a silicone resin, an epoxy resin, a phenolic resin, a urea resin, a melamine resin, and a cross-linkable thermosetting resin other than these), and a photocurable resin (more specifically, an epoxy-acrylic acid resin and a urethane-acrylic acid copolymer).

Of these resins, a polycarbonate resin is favorable because a single-layer photosensitive layer and a charge transporting layer having an excellent balance of workability, mechanical strength, optical characteristics, and wear resistance can be obtained. Examples of the polycarbonate resin include a bisphenol Z-type polycarbonate resin, a bisphenol B-type polycarbonate resin, a bisphenol ZC-type polycarbonate resin, a bisphenol C-type polycarbonate resin, and a bisphenol A-type polycarbonate resin. As the binder resin, a bisphenol Z-type polycarbonate resin or a bisphenol B-type polycarbonate resin is favorable. The bisphenol Z-type polycarbonate resin is a resin including a repeating unit represented by the formula (BisZ). The bisphenol B-type polycarbonate resin is a resin including a repeating unit represented by the formula (BisB).

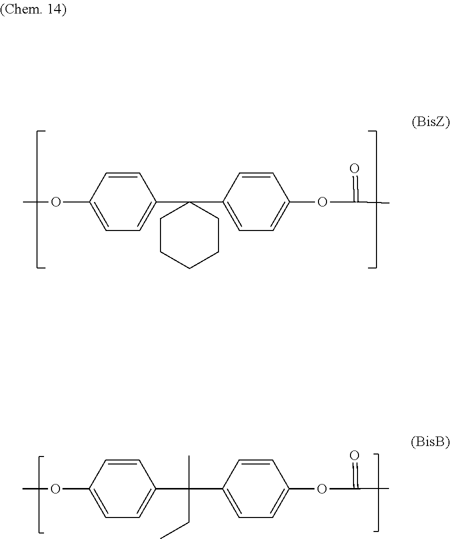

### (Base Resin)

Examples of the base resin included in the charge generating layer are the same as the examples of the binder resin included in the charge transporting layer. However, in order to suitably form a charge generating layer and a charge transporting layer, it is favorable to select, as a base resin, a resin different from the resin used as the binder resin, of the above examples of the binder resin. The base resin is, for example, a polyvinylacetal resin.

### (Additive)

Examples of the additive included in the photosensitive layer include an ultraviolet absorber, an antioxidant, a radical scavenger, a singlet quencher, a softener, a surface modifier, a bulking agent, a thickener, a dispersion stabilizer, a wax, a donor, a surfactant, a plasticizer, a sensitizer, an electron acceptor compound, and a leveling agent. Examples of the leveling agent include silicone oil, more specifically, dimethylsilicone oil.

### <Intermediate Layer>

The presence of the intermediate layer makes the flow of currents generated when the photoreceptor is exposed smooth and makes it possible to suppress an increase in resistance, while maintaining the insulated state to the extent that leakage can be suppressed. The intermediate layer (undercoat layer) includes, for example, one or both of an inorganic particle and an organic particle, and a resin used for the intermediate layer (hereinafter, referred to as an “intermediate layer resin” in some cases). Hereinafter, the inorganic particle and the organic particle included in the intermediate layer will be collectively referred to as an intermediate layer particle. The ratio of the mass of the intermediate layer particle to the mass of the intermediate layer resin is, for example, 1 or more and 4 or less. The thickness of the intermediate layer is, for example, 0.1 μm or more and 5 μm or less.

Examples of the inorganic particle of the intermediate layer particle include a white pigment (more specifically, titanium oxide, zinc oxide, zinc flower, zinc sulfide, white lead, lithopone, and the like), and an extender pigment (more specifically, alumina, calcium carbonate, barium sulfate, and the like). Examples of the organic particle of the intermediate layer particle include a fluoropolymer particle, a benzoguanamine resin particle, and a styrene resin particle. The number average primary particle size of the intermediate layer particle is favorably 100 nm or less, more favorably 1 nm or more and 50 nm or less. As the intermediate layer particle, an inorganic particle is favorable and titanium oxide is more favorable. Titanium oxide may be subjected to surface treatment. The surface treatment of titanium oxide may be performed once or a plurality of times (e.g., twice). Examples of the surface treatment agent used for the surface treatment of titanium oxide include alumina, silica, and an organosilicon compound (e.g., polysiloxane, more specifically, methylhydrogenpolysiloxane).

Examples of the intermediate layer resin are the same as the examples of the binder resin included in the photosensitive layer. However, in order to suitably form a photosensitive layer, it is favorable to select, as an intermediate layer resin, a resin different from the resin used as the binder resin, of the above examples of the binder resin. The intermediate layer resin is, for example, a polyamide resin.

### <Conductive Substrate>

The conductive substrate is not particularly limited, and at least the surface portion thereof only needs to be formed of a material having conductivity. One example of the conductive substrate is a conductive substrate formed of a material having conductivity. Another example of the conductive substrate is a conductive substrate covered with a material having conductivity. Examples of the material having conductivity include aluminum, iron, copper, tin, platinum, silver, vanadium, molybdenum, chromium, cadmium, titanium, nickel, palladium, and indium. Two or more materials having conductivity may be combined and used as an alloy (more specifically, an aluminum alloy, stainless steel, brass, or the like). As the material having conductivity, aluminum and an aluminum alloy are favorable because they provide good charge transfer from the photosensitive layer to the conductive substrate. The shape of the conductive substrate is appropriately selected in accordance with the structure of the image forming apparatus. Examples of the shape of the conductive substrate include a sheet shape and a drum shape. Further, the thickness of the conductive substrate is appropriately selected in accordance with the shape of the conductive substrate.

### <Method of Producing Photoreceptor>

Next, an example of a method of producing a photoreceptor for producing the photoreceptor according to the first embodiment will be described. The method of producing a photoreceptor includes, for example, a photosensitive layer forming step and a protective layer forming step.

### (Step of Forming Photosensitive Layer of Single-Layer Photoreceptor)

A photosensitive layer forming step in the case where the photoreceptor is a single-layer photoreceptor will be described. The step of forming a photosensitive layer of a single-layer photoreceptor includes a single-layer photosensitive layer forming step. In the single-layer photosensitive layer forming step, a coating liquid for forming a single-layer photosensitive layer (hereinafter, referred to as a coating liquid for a single-layer photosensitive layer in some cases) is prepared. The coating liquid for a single-layer photosensitive layer includes, for example, a charge generating agent, a hole transporting agent, a binder resin, a solvent, an electron transporting agent as necessary, and an additive as necessary. The coating liquid for a single-layer photosensitive layer is prepared by mixing these. Subsequently, the coating liquid for a single-layer photosensitive layer is applied onto the conductive substrate. Subsequently, at least part of the solvent included in the applied coating liquid for a photosensitive layer is removed to form a single-layer photosensitive layer.

### (Step of Forming Photosensitive Layer of Stacked Photoreceptor)

A photosensitive layer forming step in the case where the photoreceptor is a stacked photoreceptor will be described. The step of forming a photosensitive layer of a stacked photoreceptor includes a charge generating layer forming step and a charge transporting layer forming step.

In the charge generating layer forming step, a coating liquid for forming a charge generating layer (hereinafter, referred to as a coating liquid for a charge generating layer in some cases) is prepared. The coating liquid for a charge generating layer includes, for example, a charge generating agent, a base resin, a solvent, and an additive as necessary. The coating liquid for a charge generating layer is prepared by mixing these. Subsequently, the coating liquid for a charge generating layer is applied onto the conductive substrate. Subsequently, at least part of the solvent included in the applied coating liquid for a charge generating layer is removed to form a charge generating layer.

In the charge transporting layer forming step, a coating liquid for forming a charge transporting layer (hereinafter, referred to as a coating liquid for a charge transporting layer in some cases) is prepared. The coating liquid for a charge transporting layer includes a hole transporting agent, a binder resin, a solvent, and an additive as necessary. The coating liquid for a charge transporting layer is prepared by mixing these. Subsequently, the coating liquid for a charge transporting layer is applied onto the charge generating layer. Subsequently, at least part of the solvent included in the applied coating liquid for a charge transporting layer is removed to form a charge transporting layer.

### (Protective Layer Forming Step)

In the protective layer forming step, a protective layer is formed on the photosensitive layer. First, a coating liquid for a protective layer is prepared. The coating liquid for a protective layer includes, for example, at least one compound for forming a photocurable resin, a metal oxide, a solvent, a polymerization initiator as necessary, and an additive as necessary. The coating liquid for a protective layer is prepared by mixing these. Subsequently, the coating liquid for a protective layer is applied onto the photosensitive layer. Subsequently, the at least one compound for forming a photocurable resin included in the coating liquid for a protective layer on the photosensitive layer is polymerized. The polymerization forms a photocurable resin that is a polymerized product.

By applying ultraviolet rays to the coating liquid for a protective layer, the at least one compound for forming a photocurable resin included in the coating liquid for a protective layer is polymerized. The ultraviolet rays to be applied in the protective layer forming step are applied from, for example, a light-emitting diode light source. In order to suitably progress the photocuring reaction, the wavelength of the ultraviolet rays to be applied in the protective layer forming step is favorably 200 nm or more and 420 nm or less, more favorably 270 nm or more and 420 nm or less, and more favorably 365 nm. The accumulated light amount of ultraviolet rays to be applied in the protective layer forming step is favorably 10000 mW-s or more and 100000 mW-s or less, more favorably 60300 mW-s or more and 86400 mW-s or less. When the accumulated light amount of ultraviolet rays is 10000 mW-s or more, the photocuring reaction suitably progresses and it is possible to suitably cure the protective layer. When the accumulated light amount of ultraviolet rays is 100000 mW-s or less, it is possible to further suppress decomposition of the hole transporting agent included in the photosensitive layer and further improve the sensitivity characteristics of the photoreceptor.

The photosensitive layer forming step and the protective layer forming step have been described above. The method of producing a photoreceptor will be further described below.

The solvent included in each of the above coating liquid for a single-layer photosensitive layer, coating liquid for a charge generating layer, coating liquid for a charge transporting layer, and coating liquid for a protective layer (hereinafter, collectively referred to as a coating liquid in some cases) is not particularly limited as long as the components included in the coating liquid can be dissolved or dispersed. Examples of the solvent include an alcohol (more specifically, methanol, ethanol, isopropanol, butanol, and the like), an aliphatic hydrocarbon (more specifically, n-hexane, octane, cyclohexane, and the like), an aromatic hydrocarbon (more specifically, benzene, toluene, xylene, and the like), a halogenated hydrocarbon (more specifically, methylene chloride, chloroform, ethylene chloride, dichloromethane, dichloroethane, carbon tetrachloride, chlorobenzene, and the like), ether (more specifically, dioxane, dimethylether, diethylether, tetrahydrofuran, ethylene glycol dimethylether, propylene glycol monomethylether, diethylene glycol dimethylether, and the like), a ketone (more specifically, acetone, methyl ethyl ketone, 2-butanone, cyclohexanone, and the like), ester (more specifically, ethyl acetate, methyl acetate, and the like), dimethylformaldehyde, dimethylformamide, and dimethylsulfoxide.

The coating liquid is prepared by mixing the respective components and dissolving or dispersing them in a solvent. For mixing, for example, a bead mill, a ball mill, a roll mill, a paint shaker, or an ultrasonic disperser can be used.

The method of applying the coating liquid is not particularly limited as long as the coating liquid can be uniformly applied. Examples of the application method include a dip coating method, a spray coating method, a bead coating method, and a roller coating method.

Examples of the method of removing at least part of the solvent included in each of the above coating liquid for a single-layer photosensitive layer, coating liquid for a charge generating layer, and coating liquid for a charge transporting layer include heating, reduction of pressure, and a combination of heating and reduction of pressure. More specifically, a method of performing heat treatment (hot air drying) using a high-temperature dryer or a reduced-pressure dryer may be used. The temperature of the heat treatment is, for example, 40° C. or more and 150° C. or less. The time of the heat treatment is, for example, 3 minutes or more and 150 minutes or less.

The method of producing a photoreceptor may further include, as necessary, an intermediate layer forming step of forming an intermediate layer on the conductive substrate. Note that the intermediate layer forming step only needs to be performed by appropriately selecting a known method.

### Second Embodiment: Image Forming Apparatus

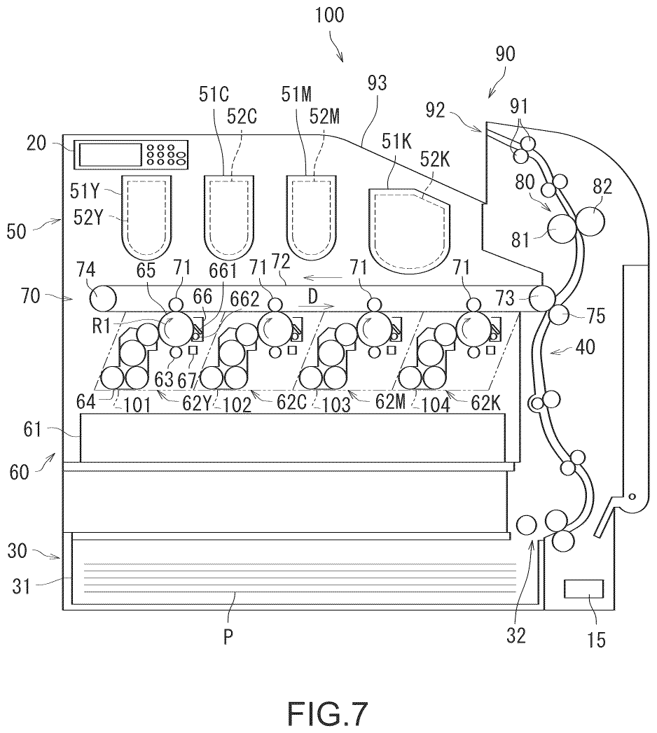

Next, an image forming apparatus 100 that is an example of an image forming apparatus according to a second embodiment of the present invention will be described with reference to FIG. 7. FIG. 7 is a diagram showing an example of a configuration of the image forming apparatus 100. The image forming apparatus 100 is, for example, a tandem-type color printer.

As shown in FIG. 7, the image forming apparatus 100 includes a control unit 15, an operation unit 20, a paper feed unit 30, a conveying unit 40, a toner supply unit 50, an image forming unit 60, a transfer device 70, a fixing device 80, and an output unit 90.

The control unit 15 controls the operation of the respective units of the image forming apparatus 100. The control unit 15 includes a processor (not shown) and a storage unit (not shown). The processor includes, for example, a central processing unit (CPU). The storage unit includes a memory such as a semiconductor memory and may include a hard disk drive (HDD). The processor executes a control program to control the operation of the image forming apparatus 100. The storage unit stores the control program.

The operation unit 20 accepts an instruction from a user. The operation unit 20 transmits, upon accepting an instruction from a user, a signal indicating the instruction from a user to the control unit 15. As a result, an image forming operation by the image forming apparatus 100 is started.

The paper feed unit 30 includes a paper feed cassette 31 and a paper feed roller group 32. The paper feed cassette 31 is capable of housing a plurality of recording media P (e.g., sheets of paper). The paper feed roller group 32 feeds the recording media P housed in the paper feed cassette 31 to the conveying unit 40 one sheet at a time.

The conveying unit 40 includes a roller and a guide member. The conveying unit 40 extends from the paper feed unit 30 to the output unit 90. The conveying unit 40 conveys the recording medium P from the paper feed unit 30 to the output unit 90 through the image forming unit 60 and the fixing device 80.

The toner supply unit 50 supplies a toner to the image forming unit 60. The toner supply unit 50 includes a first mounting portion 51Y, a second mounting portion 51C, a third mounting portion 51M, and a fourth mounting portion 51K.

A first toner container 52Y is mounted on the first mounting portion 51Y. Similarly, a second toner container 52C, a third toner container 52M, and a fourth toner container 52K are respectively mounted on the second mounting portion 51C, the third mounting portion 51M, and the fourth mounting portion 51K.

A toner is housed in each of the first toner container 52Y, the second toner container 52C, the third toner container 52M, and the fourth toner container 52K. In the second embodiment, a yellow toner is housed in the first toner container 52Y. A cyan toner is housed in the second toner container 52C. A magenta toner is housed in the third toner container 52M. A black toner is housed in the fourth toner container 52K.

The image forming unit 60 includes an exposure device 61, a first image formation unit 62Y, a second image formation unit 62C, a third image formation unit 62M, and a fourth image formation unit 62K.

Each of the first image formation unit 62Y to the fourth image formation unit 62K includes a charging device 63, a development device 64, an image carrier 65, a cleaning device 66, and a static elimination device 67.

Note that regarding the configurations of the first image formation unit 62Y to the fourth image formation unit 62K, only the type of toner to be supplied from the toner supply unit 50 differs and the other configurations are the same. For this reason, in FIG. 7, the configuration of each of the second image formation unit 62C to the fourth image formation unit 62K is shown with the reference symbol omitted.

The image carrier 65 is the photoreceptor according to the first embodiment (more specifically, the single-layer photoreceptor 1 and the stacked photoreceptor 10). As described in the first embodiment, the photoreceptor according to the first embodiment is capable of suppressing the overshoot of the charging potential and has excellent wear resistance. Therefore, the image forming apparatus 100 according to the second embodiment is capable of suppressing the overshoot of the charging potential and improving wear resistance of the photoreceptor.

In the second embodiment, the image carrier 65 rotates in a direction indicated by an arrow R1 in FIG. 7 (clockwise direction in FIG. 7). The charging device 63, the development device 64, the cleaning device 66, and the static elimination device 67 are disposed along the circumferential surface of the image carrier 65 in the order described from the upstream side in the rotation direction of the image carrier 65.

The charging device 63 charges the surface (circumferential surface) of the image carrier 65. The charging device 63 uniformly charges the image carrier 65 to predetermined polarity by electric discharge. The charging device 63 is, for example, a charging roller.

The exposure device 61 exposes the charged surface of the image carrier 65. In detail, the exposure device 61 applies laser light to the charged surface of the image carrier 65. In this way, an electrostatic latent image is formed on the surface of the image carrier 65.

A toner is supplied from the toner supply unit 50 to the development device 64. The development device 64 supplies the toner supplied from the toner supply unit 50 to the surface of the image carrier 65. As a result, the electrostatic latent image formed on the surface of the image carrier 65 is developed as a toner image.

In the second embodiment, the development device 64 of the first image formation unit 62Y is connected to the first toner container 52Y. For this reason, a yellow toner is supplied to the development device 64 of the first image formation unit 62Y. Therefore, a yellow toner image is formed on the surface of the image carrier 65 of the first image formation unit 62Y.

Similarly, the development device 64 of the second image formation unit 62C, the development device 64 of the third image formation unit 62M, and the development device 64 of the fourth image formation unit 62K are respectively connected to the second toner container 52C, the third toner container 52M, and the fourth toner container 52K. For this reason, a cyan toner, a magenta toner, and a black toner are respectively supplied to the development device 64 of the second image formation unit 62C, the development device 64 of the third image formation unit 62M, and the development device 64 of the fourth image formation unit 62K. Therefore, a cyan toner image, a magenta toner image, and a black toner image are respectively formed on the surface of the image carrier 65 of the second image formation unit 62C, the surface of the image carrier 65 of the third image formation unit 62M, and the surface of the image carrier 65 of the fourth image formation unit 62K.

The cleaning device 66 includes a cleaning member 661 and a rubbing roller 662. After transfer by a primary transfer roller 71 described below, the cleaning member 661 is pressed against the surface of the image carrier 65 to collect the toner adhering to the surface of the image carrier 65. The cleaning member 661 is, for example, a cleaning blade. The rubbing roller 662 rubs the surface of the image carrier 65 to polish the surface of the image carrier 65.

The static elimination device 67 applies static elimination light to the surface of the image carrier 65 to eliminate static electricity on the surface of the image carrier 65.

The transfer device 70 transfers a toner image from the image carrier 65 to the recording medium P that is a to-be-transferred body. In detail, the transfer device 70 transfers each toner image formed on the surface of each image carrier 65 of the first image formation unit 62Y to the fourth image formation unit 62K onto the recording medium P in a superimposed manner. In the second embodiment, the transfer device 70 transfers each toner image onto the recording medium P in a superimposed manner using a secondary transfer method (intermediate transfer method). The transfer device 70 includes four primary transfer rollers 71, an intermediate transfer belt 72, a drive roller 73, a driven roller 74, and a secondary transfer roller 75.

The intermediate transfer belt 72 is an endless belt stretched over the four primary transfer rollers 71, the drive roller 73, and the driven roller 74. The intermediate transfer belt 72 is driven in accordance with rotation of the drive roller 73. The intermediate transfer belt 72 rotates counterclockwise in FIG. 7. The driven roller 74 is driven to rotate in accordance with the drive of the intermediate transfer belt 72.

The first image formation unit 62Y to the fourth image formation unit 62K are disposed to face the lower surface of the intermediate transfer belt 72. In the second embodiment, the first image formation unit 62Y to the fourth image formation unit 62K are disposed in the order of the first image formation unit 62Y to the fourth image formation unit 62K from the upstream side to the downstream side in a drive direction D of the lower surface of the intermediate transfer belt 72.

Each primary transfer roller 71 is disposed to face the corresponding image carrier 65 via the intermediate transfer belt 72 and is pressed toward the image carrier 65. For this reason, the toner image formed on the surface of each image carrier 65 by each primary transfer roller 71 is sequentially transferred onto the intermediate transfer belt 72. In the second embodiment, a yellow toner image, a cyan toner image, a magenta toner image, and a black toner image are transferred onto the intermediate transfer belt 72 in this order in a superimposed manner. Hereinafter, the toner image obtained by superimposing a yellow toner image, a cyan toner image, a magenta toner image, and a black toner image will be referred to as a “stacked toner image” in some cases.

The secondary transfer roller 75 is disposed to face the drive roller 73 via the intermediate transfer belt 72. The secondary transfer roller 75 is pressed toward the drive roller 73. This forms a transfer nip between the secondary transfer roller 75 and the drive roller 73. When the recording medium P passes through the transfer nip, the stacked toner image on the intermediate transfer belt 72 is transferred onto the recording medium P by the secondary transfer roller 75. In the second embodiment, a yellow toner image, a cyan toner image, a magenta toner image, and a black toner image are transferred onto the recording medium P in this order as the top layer to the bottom layer. The recording medium P onto which the stacked toner image has been transferred is conveyed toward the fixing device 80 by the conveying unit 40.

The fixing device 80 includes a heating member 81 and a pressure member 82. The heating member 81 and the pressure member 82 are disposed to face each other to form a fixing nip. The recording medium P conveyed from the image forming unit 60 is pressurized while being heated at a predetermined fixing temperature by passing through the fixing nip. As a result, the stacked toner image is fixed to the recording medium P. The recording medium P is conveyed from the fixing device 80 to the output unit 90 by the conveying unit 40.

The output unit 90 includes an output roller pair 91 and an output tray 93. The output roller pair 91 conveys the recording medium P to the output tray 93 via an output port 92. The output port 92 is formed in the upper part of the image forming apparatus 100.

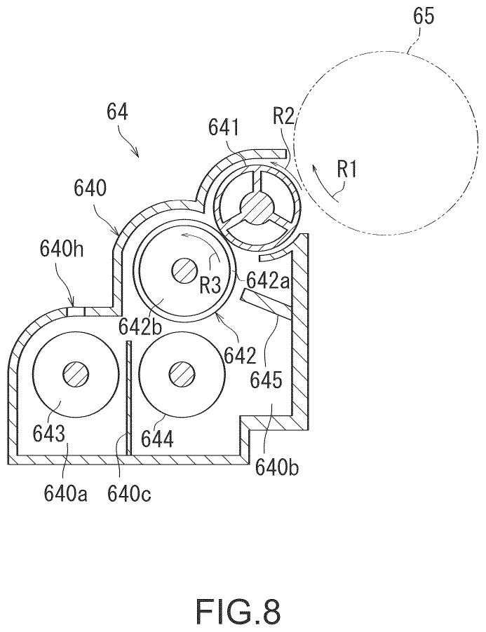

Next, a configuration of the development device 64 will be described in detail with reference to FIG. 8. FIG. 8 is a diagram showing an example of a configuration of the development device 64. In detail, FIG. 8 shows the development device 64 of the first image formation unit 62Y. Note that in FIG. 8, the image carrier 65 is illustrated by a two-dot chain line for ease of understanding. In the second embodiment, the development device 64 adopts a two-component development method using a two-component developer and a touch-down development method.

As described above with reference to FIG. 7, a development container 640 of the development device 64 is connected to the first toner container 52Y. Therefore, a yellow toner is supplied to the development container 640 of the development device 64 via a toner supply port 640h.

As shown in FIG. 8, the development device 64 includes, inside the development container 640, a development roller 641, a magnetic roller 642, a first stirring screw 643, a second stirring screw 644, and a blade 645. In detail, the development roller 641 is disposed to face the magnetic roller 642. The magnetic roller 642 is disposed to face the second stirring screw 644. The blade 645 is disposed to face the magnetic roller 642.

The development container 640 is divided into a first stirring chamber 640a and a second stirring chamber 640b by a partition wall 640c. The partition wall 640c extends in the axial direction of the development roller 641. The first stirring chamber 640a and the second stirring chamber 640b communicate with each other on the outside at both ends of the partition wall 640c in the longitudinal direction.

The first stirring screw 643 is disposed in the first stirring chamber 640a. A carrier that is a magnetic material is housed in the first stirring chamber 640a. A toner that is a non-magnetic material is supplied to the first stirring chamber 640a via the toner supply port 640h. In the example shown in FIG. 8, a yellow toner is supplied to the first stirring chamber 640a.

The second stirring screw 644 is disposed in the second stirring chamber 640b. A carrier that is a magnetic material is housed in the second stirring chamber 640b.

The yellow toner is stirred with the carrier by the first stirring screw 643 and the second stirring screw 644. As a result, a two-component developer that includes a carrier and a yellow toner is formed. In this way, the two-component developer is housed in the development container 640 (more specifically, the first stirring chamber 640a and the second stirring chamber 640b).

The first stirring screw 643 and the second stirring screw 644 stir the two-component developer while circulating it between the first stirring chamber 640a and the second stirring chamber 640b. As a result, the toner is charged to predetermined polarity by friction with the carrier.

Note that in the case where the image carrier 65 is the single-layer photoreceptor 1, the surface of the image carrier 65 and the toner are charged to, for example, positive polarity. In the case where the image carrier 65 is the stacked photoreceptor 10, the surface of the image carrier 65 and the toner are charged to, for example, negative polarity.

The magnetic roller 642 includes a non-magnetic rotating sleeve 642a and a magnet body 642b. The magnet body 642b is fixed to and disposed in the rotating sleeve 642a. The magnet body 642b includes a plurality of magnetic poles. The two-component developer is attracted to the magnetic roller 642 by the magnetic force of the magnet body 642b. As a result, a magnetic brush is formed on the surface of the magnetic roller 642.

The blade 645 is disposed on the upstream side in the rotation direction of the magnetic roller 642 than the position where the magnetic roller 642 and the development roller 641 face each other. In the second embodiment, the magnetic roller 642 rotates in a direction indicated by an arrow R³ in FIG. 8 (counterclockwise direction in FIG. 8). The magnetic roller 642 rotates to convey the magnetic brush to the position facing the blade 645. The blade 645 is disposed such that a gap is formed between the blade 645 and the magnetic roller 642. The blade 645 is formed of a magnetic material. Therefore, the thickness of the magnetic brush is regulated by the magnetic force of the blade 645.

After the thickness of the magnetic brush on the magnetic roller 642 is regulated, a predetermined voltage is applied to the magnetic roller 642 and the development roller 641. When the predetermined voltage is applied to obtain a predetermined potential difference between the magnetic roller 642 and the development roller 641, the yellow toner included in the two-component developer migrates to the development roller 641. As a result, the toner thin layer including the yellow toner is formed on the surface of the development roller 641.

The development roller 641 rotates in a direction indicated by an arrow R2 in FIG. 8 (counterclockwise direction in FIG. 8). This causes the toner thin layer formed on the surface of the development roller 641 to be conveyed to the position facing the image carrier 65 and adhere to the image carrier 65. In this way, the development device 64 supplies the toner charged due to the friction with the carrier to the surface of the image carrier 65.

The development device 64 of the first image formation unit 62Y has been described above with reference to FIG. 8. Regarding the configuration of the development device 64 of each of the first image formation unit 62Y to the fourth image formation unit 62K, only the type of toner to be supplied from the toner supply unit 50 differs and the other configurations are the same. For this reason, description of the configuration of the development device 64 of each of the second image formation unit 62C to the fourth image formation unit 62K is omitted.

The image forming apparatus 100 that is an example of the image forming apparatus according to the second embodiment has been described above with reference to FIG. 7 and FIG. 8. However, the image forming apparatus according to the second embodiment is not limited to the image forming apparatus 100. For example, the image forming apparatus may be a monochrome image forming apparatus. In this case, the image forming apparatus only needs to include one image formation unit. The image forming apparatus may adopt a rotary method. The charging device may be a charging device other than the charging roller (e.g., a scorotron charger, a charging brush, or a corotron charger). The image forming apparatus may adopt a one-component development method using a one-component developer. The image forming apparatus may adopt a development method other than the touch-down development method (e.g., a development method in which no development roller is provided and a magnetic roller serves also as a development roller). The image forming apparatus may adopt a direct transfer method. In the case where the image forming apparatus adopts a direct transfer method, a toner image is directly transferred to a recording medium from an image carrier while the image carrier is in contact with the recording medium. The image forming apparatus does not necessarily need to include a cleaning device. The image forming apparatus does not necessarily need to include a static elimination device. The image forming apparatus according to the second embodiment has been described above.

### Third Embodiment: Process Cartridge

Next, a first process cartridge 101, a second process cartridge 102, a third process cartridge 103, and a fourth process cartridge 104, which are examples of a process cartridge according to a third embodiment of the present invention, will be described with continued reference to FIG. 7. The first process cartridge 101 to the fourth process cartridge 104 according to the third embodiment respectively correspond to the first image formation unit 62Y to the fourth image formation unit 62K. Each of the first process cartridge 101 to the fourth process cartridge 104 includes the image carrier 65. The image carrier 65 is the photoreceptor according to the first embodiment (more specifically, the single-layer photoreceptor 1 and the stacked photoreceptor 10).

As described in the first embodiment, the photoreceptor according to the first embodiment is capable of suppressing the overshoot of the charging potential and has excellent wear resistance. Therefore, the process cartridge according to the third embodiment is capable of suppressing the overshoot of the charging potential and improving the wear resistance of the photoreceptor.

The process cartridge according to the third embodiment may further include at least one (e.g., 1 or more and 7 or less) selected from the group consisting of the charging device 63, the exposure device 61, the development device 64, the transfer device 70 (particularly, the primary transfer roller 71), the cleaning member 661, the rubbing roller 662, and the static elimination device 67, in addition to the image carrier 65.

Each of the first process cartridge 101, the second process cartridge 102, the third process cartridge 103, and the fourth process cartridge 104 shown in FIG. 7 includes the image carrier 65, the charging device 63, the development device 64, the cleaning device 66 including the cleaning member 661 and the rubbing roller 662, and the static elimination device 67, similarly to the first image formation unit 62Y, the second image formation unit 62C, the third image formation unit 62M, and the fourth image formation unit 62K. However, the process cartridge according to the third embodiment is not limited to the first process cartridge 101 to the fourth process cartridge 104. As described above, the process cartridge according to the third embodiment may further include at least one of the exposure device 61 or the transfer device 70 and may include only one of the cleaning member 661 and the rubbing roller 662 (e.g. only the cleaning member 661). In any case, the process cartridge according to the third embodiment only needs to include the photoreceptor according to the first embodiment as the image carrier 65.

The process cartridge according to the third embodiment is designed to be attachable/detachable to/from the image forming apparatus 100. For this reason, the process cartridge is easy to handle, and can be easily and quickly replaced together with the image carrier 65 in the case where the sensitivity characteristics or the like of the image carrier 65 deteriorate. The process cartridge according to the third embodiment has been described above with reference to FIG. 7.

### [Substituent Group]

The substituent group used in the present specification will be described below. Examples of the halogen atom (halogen group) include a fluorine atom (fluoro group), a chlorine atom (chloro group), a bromine atom (bromo group), and an iodine atom (iodo group).

Unless otherwise specified, each of the alkyl group having 1 or more and 8 or less carbon atoms, the alkyl group having 1 or more and 6 or less carbon atoms, the alkyl group having 1 or more and 5 or less carbon atoms, and the alkyl group having 1 or more and 3 or less carbon atoms is linear or branched chain and unsubstituted. Examples of the alkyl group having 1 or more and 8 or less carbon atoms include a methyl group, an ethyl group, an n-propyl group, an isopropyl group, an n-butyl group, a sec-butyl group, a tert-butyl group, an n-pentyl group, a 1-methylbutyl group, a 2-methylbutyl group, a 3-methylbutyl group, a 1-ethylpropyl group, a 2-ethylpropyl group, a 1,1-dimethylpropyl group, a 1,2-dimethylpropyl group, a 2,2-dimethylpropyl group, an n-hexyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 3,3-dimethylbutyl group, a 1,1,2-trimethylpropyl group, a 1,2,2-trimethylpropyl group, a 1-ethylbutyl group, a 2-ethylbutyl group, a 3-ethylbutyl group, linear and branched chain heptyl groups, and linear and branched chain octyl groups. Examples of the alkyl group having 1 or more and 6 or less carbon atoms, the alkyl group having 1 or more and 5 or less carbon atoms, and the alkyl group having 1 or more and 3 or less carbon atoms are groups having the corresponding number of carbon atoms, of the groups mentioned as the examples of the alkyl group having 1 or more and 8 or less carbon atoms.

Unless otherwise specified, the alkoxy group having 1 or more and 6 or less carbon atoms is linear or branched chain and unsubstituted. Examples of the alkoxy group having 1 or more and 6 or less carbon atoms include a methoxy group, an ethoxy group, an n-propoxy group, an isopropoxy group, an n-butoxy group, a sec-butoxy group, a tert-butoxy group, an n-pentoxy group, a 1-methylbutoxy group, a methylbutoxy group, a 3-methylbutoxy group, a 1-ethylpropoxy group, a 2-ethylpropoxy group, a 1,1-dimethylpropoxy group, a 1,2-dimethylpropoxy group, a 2,2-dimethylpropoxy group, an n-hexyloxy group, a 1-methylpentyloxy group, a 2-methylpentyloxy group, a 3-methylpentyloxy group, a 4-methylpentyloxy group, a 1,1-dimethylbutoxy group, a 1,2-dimethylbutoxy group, a 1,3-dimethylbutoxy group, a 2,2-dimethylbutoxy group, a 2,3-dimethylbutoxy group, a 3,3-dimethylbutoxy group, a 1,1,2-trimethylpropoxy group, a 1,2,2-trimethylpropoxy group, a 1-ethylbutoxy group, a 2-ethylbutoxy group, and a 3-ethylbutoxy group.

Unless otherwise specified, each of the aryl group having 6 or more and 14 or less carbon atoms and the aryl group having 6 or more and 10 or less carbon atoms is unsubstituted. Examples of the aryl group having 6 or more and 14 or less carbon atoms include a phenyl group, a naphthyl group, an indacenyl group, a biphenylenyl group, an acenaphthylenyl group, an anthryl group, and a phenanthryl group. Examples of the aryl group having 6 or more and 10 or less carbon atoms are groups having the corresponding number of carbon atoms, of the groups mentioned as the examples of the aryl group having 6 or more and 14 or less carbon atoms.

Unless otherwise specified, each of the alkenyl group having 2 or more and 6 or less carbon atoms and the alkenyl group having 2 or more and 4 or less carbon atoms is linear or branched chain and unsubstituted. The alkenyl group having 2 or more and 6 or less carbon atoms has 1 or more and 3 or less double bonds. Examples of the alkenyl group having 2 or more and 6 or less carbon atoms include an ethenyl group, a propenyl group, a butenyl group, a butadienyl group, a pentenyl group, a hexenyl group, a hexadienyl group, and a hexatrienyl group. Examples of the alkenyl group having 2 or more and 4 or less carbon atoms are groups having the corresponding number of carbon atoms, of the groups mentioned as the examples of the alkenyl group having 2 or more and 6 or less carbon atoms. The substituent group used in the present specification has been described above.

### EXAMPLES

Although the present invention will be further specifically described using Examples, the present invention is not limited to the scope of the Examples.

### [Production of Single-Layer Photoreceptor]

Single-layer photoreceptors (A-1) to (A-8) and (B-1) to (B-6) were produced by the following method. The configurations of these single-layer photoreceptors are shown in Table 1 described below.

### <Production of Single-Layer Photoreceptor (A-1)>

(Formation of Single-Layer Photosensitive Layer) 2.85 parts by mass of a Y-type titanyl phthalocyanine, 62.00 parts by mass of a hole transporting agent (HTM-1), 33.50 parts by mass of an electron transporting agent (ET-1), 33.50 parts by mass of an electron transporting agent (ET-6), 138.00 parts by mass of a bisphenol Z-type polycarbonate resin, 0.02 parts by mass of a leveling agent, and 500.00 parts by mass of tetrahydrofuran were mixed using a rod-shaped sonic oscillator for 20 minutes to obtain a mixed solution b. As the bisphenol Z-type polycarbonate resin, “Iupizeta PCZ-200” manufactured by MITSUBISHI GAS CHEMICAL COMPANY, INC. was used. As the leveling agent, dimethylsilicone oil (“KF96-50CS” manufactured by Shin-Etsu Chemical Co., Ltd.) was used. The obtained mixed solution b was filtered with a filter with an opening of 5 μm to obtain a coating liquid for a single-layer photosensitive layer. The coating liquid for a single-layer photosensitive layer was applied onto the conductive substrate by a dip coating method and dried at 110° C. for 60 minutes to form a single-layer photosensitive layer (film thickness: 25 μm) on the conductive substrate. As the conductive substrate, a drum-shaped support formed of aluminum was used.

### (Formation of Protective Layer)

4.4 parts by mass of phosphorus-doped tin oxide, 45.0 parts by mass of a multifunctional group monomer, 5.0 parts by mass of a polymerization initiator, and 76.0 parts by mass of methanol were mixed using a bead mill for 12 hours to obtain a mixed solution c. As the phosphorus-doped tin oxide, “SP-2” manufactured by Mitsubishi Materials Electronic Chemicals Co., Ltd. (BET specific surface area of 105±25 m²/g) was used. As the multifunctional group monomer, “A-TMM-3LM-N” manufactured by SHIN-NAKAMURA CHEMICAL CO, LTD. (mixture of the compounds represented by the formulae (EA-1) and (EA-2) described in the first embodiment, the compound represented by the formula (EA-1) having the number of polymerizable functional groups of 3, the compound represented by the formula (EA-2) having the number of polymerizable functional groups of 4, the content ratio of the compound represented by the formula (EA-1) occupied in the mixture being 57 mass %) was used. As the polymerization initiator, 2,4,6-trimethylbenzoyl-diphenylphosphineoxide (“OMNIRAD TPO” manufactured by IGM Resins B.V.) was used. The obtained mixed solution c was filtered with a filter with an opening of 5 μm to obtain a coating liquid for a protective layer. Subsequently, the coating liquid for a protective layer was applied onto the single-layer photosensitive layer by a dip coating method. Ultraviolet rays with a wavelength of 365 nm and a UV intensity of 2400 mW/cm² were applied to the applied coating liquid for a protective layer for 36 seconds. The application of ultraviolet rays polymerized (photocuring reaction) the multifunctional group monomer in the coating liquid for a protective layer to form a photocurable resin. In this way, a protective layer (film thickness: 1.0 μm) was formed on the single-layer photosensitive layer to obtain a single-layer photoreceptor (A-1). The protective layer included the photocurable resin cured by the photocuring reaction, the phosphorus-doped tin oxide, and the polymerization initiator.

### <Production of Single-Layer Photoreceptors (A-2) to (A-8) and (B-1) to (B-5)>

Single-layer photoreceptors (A-2) to (A-8) and (B-1) to (B-5) were produced in the same manner as in the production of the single-layer photoreceptor (A-1) except that hole transporting agents shown in Table 1 were used. Hole transporting agents (HTM-9) to (HTM-13) used in Comparative Examples shown in Table 1 are respectively represented by the following formulae (HTM-9) to (HTM-13).

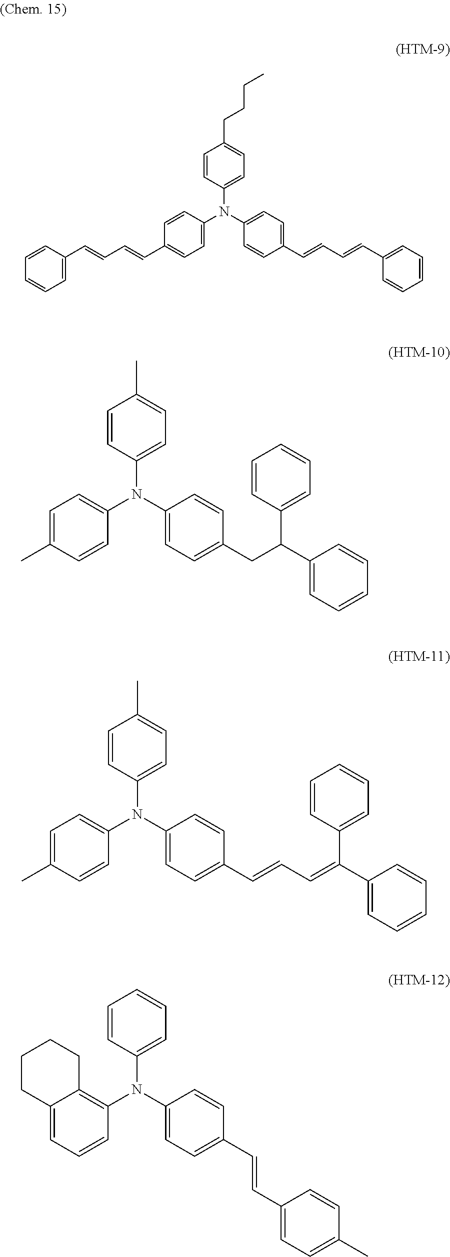 [SMILES: CCCCc1ccc(N(c2ccc(/C=C/C=C/c3ccccc3)cc2)c2ccc(/C=C/C=C/c3ccccc3)cc2)cc1 ; Cc1ccc(N(c2ccc(C)cc2)c2ccc(CC(c3ccccc3)c3ccccc3)cc2)cc1 ; Cc1ccc(N(c2ccc(C)cc2)c2ccc(/C=C/C=C(c3ccccc3)c3ccccc3)cc2)cc1 ; Cc1ccc(/C=C/c2ccc(N(c3ccccc3)c3cccc4c3CCCC4)cc2)cc1]

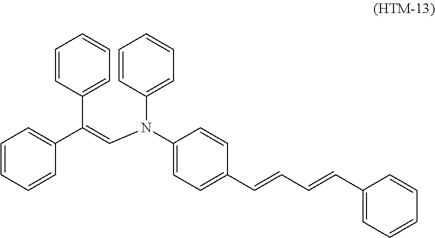 [SMILES: C(=C(c1ccccc1)c1ccccc1)N(c1ccccc1)c1ccc(/C=C/C=C/c2ccccc2)cc1]

### <Production of Single-Layer Photoreceptor (B-6)>

A single-layer photoreceptor (B-6) was produced in the same manner as in the production of the single-layer photoreceptor (A-1) except that the hole transporting agent shown in Table 1 was used and the above formation of a protective layer was not performed.

### [Measurement of Single-Layer Photoreceptor]

The residual ratio Z of each single-layer photoreceptor was measured by the following method. The measurement results are shown in Table 1.

### <Residual Ratio Z of Hole Transporting Agent>

33.5 parts by mass of a hole transporting agent (more specifically, one of hole transporting agents (HTM-1) to (HTM-13)), 138.0 parts by mass of a bisphenol Z-type polycarbonate resin (“Iupizeta PCZ-200” manufactured by MITSUBISHI GAS CHEMICAL COMPANY, INC., a viscosity average molecular weight of 21,500, a glass transition temperature of 174° C.), and 3322.0 parts by mass of tetrahydrofuran were mixed using a bead mill for 12 hours to obtain a coating liquid for residual ratio measurement. Subsequently, the coating liquid for residual ratio measurement was applied onto an overhead projector (OHP) film using a wire bar and heated at 100° C. for 60 minutes. In this way, a sheet containing a hole transporting agent or the like (film thickness of 3 μm), which was a measurement target, was formed on the OHP film. A sample including the sheet containing a hole transporting agent or the like and the OHP film was cut into two equal pieces to obtain two samples S1 and S2.

The sample S1 was set in the film holder of an ultraviolet-visible spectrophotometer (“U-3010” manufactured by Hitachi, Ltd.). The sample S1 was measured using the above ultraviolet-visible spectrophotometer under the following measurement conditions. In this way, an ultraviolet-visible light absorption spectrum (spectrum before irradiation of ultraviolet rays) was obtained.

Next, predetermined ultraviolet rays having a wavelength of 365 nm and an accumulated light amount of 34200 mW-s were applied to the measurement sample S2. The sample S2 after irradiation of the predetermined ultraviolet rays was set in the film holder of the above ultraviolet-visible spectrophotometer. The measurement sample S2 after irradiation of the predetermined ultraviolet rays was measured using the above ultraviolet-visible spectrophotometer under the following measurement conditions to obtain an ultraviolet-visible light absorption spectrum (spectrum after UV irradiation).

An absorbance A1 at a wavelength of 365 nm was obtained from the spectrum before irradiation of ultraviolet rays. The obtained absorbance A1 was regarded as the absorbance A1 of the measurement target before irradiation of ultraviolet rays. Next, an absorbance A2 at a wavelength of 365 nm was obtained from the spectrum after irradiation of ultraviolet rays. The obtained absorbance A2 was regarded as the absorbance A2 of the measurement target after irradiation of ultraviolet rays. The residual ratio Z of the hole transporting agent was calculated from the absorbance A1 of the measurement target before irradiation of ultraviolet rays and the absorbance A2 of the measurement target after irradiation of ultraviolet rays on the basis of the calculation formula (I) described in the first embodiment. Note that since the bisphenol Z-type polycarbonate resin is not substantially decomposed by irradiation of predetermined ultraviolet rays, the residual ratio Z of the measurement target is regarded as the residual ratio Z of the hole transporting agent.

### (Measurement Conditions for Ultraviolet-Visible Light Absorption Spectrum)

Measurement wavelength range: range of 320.00 nm or more and 600.00 nm or less
Sampling interval: 1.00 nm
Slit width: 1 nm
Scanning speed: 300 nm/min

### [Evaluation of Single-Layer Photoreceptor]

The wear resistance, suppression of an overshoot, and sensitivity characteristics of each of the single-layer photoreceptors (A-1) to (A-8) and (B-1) to (B-6) were evaluated by the following method.

### <Evaluation Device and Evaluation Paper>

For evaluation of the wear resistance and the suppression of an overshoot of the single-layer photoreceptor, a modified machine of a color multifunction device (“Taskalfa 356ci” manufactured by KYOCERA Document Solutions Inc.) was used as an evaluation device. This evaluation device was equipped with a charging roller including an epichlorohydrin resin in which conductive carbon was dispersed. The charge polarity of the charging roller was positive polarity, and the applied voltage of the charging roller was a direct current voltage. This evaluation device adopted a two-component development method. This evaluation device was equipped with a cleaning blade, a rubbing roller, and a static elimination device. For evaluation of the wear resistance, copy paper sheet of paper.

### <Wear Resistance>

A film thickness T1 of the photosensitive layer of the photoreceptor was measured. Subsequently, the photoreceptor was mounted on the evaluation device. An image I (pattern image with a coverage rate of 1%) was printed on 10,000 sheets of paper using an evaluation device in a normal temperature and normal humidity environment of a temperature of 23° C. and a relative humidity of 50% RH. Subsequently, the image I was printed on 10,000 sheets of paper using the evaluation device in a high-temperature and high-humidity environment of a temperature of 32° C. and a relative humidity of 85% RH. Subsequently, the image I was printed on 10,000 sheets of paper using the evaluation device in a low-temperature and low-humidity environment of a temperature of 10° C. and a relative humidity of 15% RH. After that, a film thickness T2 of the photosensitive layer of the photoreceptor was measured. Then, the friction amount (T1-T2, unit: μm) that was a film thickness change amount of the photosensitive layer before and after the printing was obtained. The measured friction amount is shown in Table 1. The criteria for judging the wear resistance of the photoreceptor are shown below.

### (Criteria for Wear Resistance)

Good: the friction amount is 0.5 μm or less.
Poor: the friction amount exceeds 0.5 μm.

### <Suppression of Overshoot>

The photoreceptor was mounted on the evaluation device. A blank image was printed in a mode using no sheet of paper using the evaluation device in a normal temperature and normal humidity environment of a temperature of 23° C. and a relative humidity of 50% RH. The charging potential of the surface of the photoreceptor was measured from the start of printing (i.e., the first rotation of the photoreceptor) to the 10th rotation of the photoreceptor. The charging potential of the first rotation of the photoreceptor was represented by V001 (unit: +V) and the charging potential of the 10th rotation of the photoreceptor was represented by V010 (unit: +V). An overshoot potential Vos (unit: V) was obtained from the calculation formula “Vos=|V001|−|V0101|”. |V001| and |V010| respectively indicate the absolute value of V001 and the absolute value of V010. Note that since the charge polarity of the single-layer photoreceptor was set to the positive polarity, both V001 and V010 had positive values. When Vos has a positive value, it indicates that the absolute value of V001 is higher than the absolute value of V010. Further, the larger the positive value of Vos, the greater the degree to which the charging potential (e.g., the charging potential V001 of the first rotation) increased when the photoreceptor was started to charge by the charging device and the charging potential (e.g., the charging potential V010 of the 10th rotation) decreased in reaction thereto. The measured Vos is shown in Table 1. Note that the Vos shown in Table 1 has a positive value. The criteria for judging the suppression of an overshoot of the single-layer photoreceptor are shown below.

### (Criteria for Suppression of Overshoot)

Good: Vos is 0 V or more and 20 V or less.
Poor: Vos exceeds 20 V.

### <Sensitivity Characteristics>

The sensitivity characteristics of the photoreceptor were evaluated using a drum sensitivity tester (manufactured by GENTEC) in an environment of a temperature of 23° C. and a relative humidity of 50% RH. The surface of the photoreceptor was charged to +550 V using the drum sensitivity tester. Subsequently, monochromatic light (a wavelength: 780 nm, an exposure amount: 1.0 ρJ/cm²) was extracted using a bandpass filter from the light of a halogen lamp and applied to the surface of the photoreceptor. The surface potential of the photoreceptor at the time point when 50 ms elapsed since the end of application of monochromatic light was measured. The measured surface potential was used as the post-exposure potential VL (unit: +V) of the photoreceptor. The measured VL is shown in Table 1. The criteria for judging the sensitivity characteristics of the photoreceptor are shown below.

### (Criteria for Sensitivity Characteristics)

Good: the absolute value of VL is 140 V or less.
Poor: the absolute value of VL exceeds 140 V.

TABLE 1

| | | Single-layer photosensitive layer | | | | | | |
|---|---|---|---|---|---|---|---|---|
| | | HTM | | | | | | |
| | | | | Residual | | | Wear | |
| | Single-layer | | Molecular | ratio Z | Protective | VL | amount | Vos |
| | photoreceptor | Type | weight | [%] | layer | [+V] | [μm] | [V] |
| Ex 1 | A-1 | HTM-1 | 777.0 | 97.1 | With | 121 | 0.1 | 5 |
| Ex 2 | A-2 | HTM-2 | 671.9 | 87.3 | With | 135 | 0.1 | 13 |
| Ex 3 | A-3 | HTM-3 | 648.9 | 96.1 | With | 138 | 0.1 | 11 |
| Ex 4 | A-4 | HTM-4 | 829.1 | 82.1 | With | 110 | 0.1 | 6 |
| Ex 5 | A-5 | HTM-5 | 905.0 | 79.1 | With | 120 | 0.1 | 14 |
| Ex 6 | A-6 | HTM-6 | 615.8 | 82.8 | With | 132 | 0.1 | 14 |
| Ex 7 | A-7 | HTM-7 | 601.8 | 76.2 | With | 138 | 0.1 | 10 |
| Ex 8 | A-8 | HTM-8 | 643.9 | 78.5 | With | 137 | 0.1 | 9 |
| Comp 1 | B-1 | HTM-9 | 558.0 | 58.5 | With | 119 | 0.1 | 21 |
| Comp 2 | B-2 | HTM-10 | 452.0 | 88.6 | With | 149 | 0.1 | 35 |
| Comp 3 | B-3 | HTM-11 | 447.6 | 80.0 | With | 130 | 0.1 | 36 |
| Comp 4 | B-4 | HTM-12 | 415.6 | 72.6 | With | 161 | 0.1 | 56 |
| Comp 5 | B-5 | HTM-13 | 475.6 | 59.9 | With | 180 | 0.1 | 45 |
| Comp 6 | B-6 | HTM-1 | 777.0 | 97.1 | Without | 43 | 6.6 | 3 |

In Table 1, “Ex” indicates Example, “Comp” indicates Comparative Example, and “HTM” indicates a hole transporting agent.

As shown in Table 1, the hole transporting agent included in the single-layer photosensitive layer of each of the single-layer photoreceptors (B-1) to (B-5) was not a predetermined hole transporting agent. Each of the single-layer photoreceptors (B-1) to (B-5) was not capable of suppressing the overshoot of the charging potential.

As shown in Table 1, the single-layer photoreceptor (B-6) did not include a protective layer. The single-layer photoreceptor (B-6) had poor wear resistance.

On the other hand, as shown in Table 1, the hole transporting agent included in the single-layer photosensitive layer of each of the single-layer photoreceptors (A-1) to (A-8) was a predetermined hole transporting agent. Each of the single-layer photoreceptors (A-1) to (A-8) included a protective layer. Each of the single-layer photoreceptors (A-1) to (A-8) was capable of suppressing the overshoot of the charging potential and had excellent wear resistance. Further, each of the single-layer photoreceptors (A-1) to (A-8) had excellent sensitivity characteristics.

### [Production of Stacked Photoreceptor]

A stacked photoreceptor (C-1) was produced by the following method. The configuration of this stacked photoreceptor is shown in Table 2 described below.

### <Production of Stacked Photoreceptor (C-1)>

### (Formation of Intermediate Layer)

2 parts by mass of titanium oxide, 1 part by mass of a polyamide resin, 10 parts by mass of methanol, 1 part by mass of butanol, and 1 part by mass of toluene were mixed for 5 hours using a bead mill to obtain a mixed solution a. As the titanium oxide, a prototype “SMT-A” manufactured by TAYCA Co., Ltd. (a number average particle size of 10 nm, obtained by performing primary surface treatment on titanium oxide using alumina and silica and performing secondary surface treatment on the titanium oxide subjected to the primary surface treatment using methylhydrogenpolysiloxane) was used. As a polyamide resin, “Amilan (registered trademark) CM8000” manufactured by TORAY INDUSTRIES, INC. (quaternary copolymerized polyamide resin of polyamide 6, polyamide 12, polyamide 66, and polyamide 610) was used. The obtained mixed solution a was filtered with a filter with an opening of 5 μm to obtain a coating liquid for an intermediate layer. Subsequently, the coating liquid for an intermediate layer was applied onto the surface of the conductive substrate by a dip coating method. As the conductive substrate, a drum-shaped support formed of aluminum was used. Subsequently, the applied coating liquid for an intermediate layer was dried at 130° C. for 30 minutes to form an intermediate layer (film thickness: 0.5 μm) on the conductive substrate.

### (Formation of Charge Generating Layer)

1.5 parts by mass of a Y-type titanyl phthalocyanine, 1.0 part by mass of a polyvinylacetal resin (“S-LEC BX-5” manufactured by SEKISUI CHEMICAL CO., LTD.) as a base resin, 40.0 parts by mass of propylene glycol monomethylether, and 40.0 parts by mass of tetrahydrofuran were mixed using a bead mill for 12 hours to obtain a mixed solution d. The obtained mixed solution d was filtered with a filter with an opening of 3 μm to obtain a coating liquid for a charge generating layer. Subsequently, the coating liquid for a charge generating layer was applied onto the intermediate layer on the conductive substrate by a dip coating method. The applied coating liquid for a charge generating layer was dried at 50° C. for 5 minutes to form a charge generating layer (film thickness: 0.3 μm) on the intermediate layer.

### (Formation of Charge Transporting Layer)

62.00 parts by mass of a hole transporting agent (HTM-1), 100.00 parts by mass of a bisphenol Z-type polycarbonate resin, 0.05 parts by mass of a leveling agent, 340.00 parts by mass of tetrahydrofuran, and 60.00 parts by mass of toluene were mixed using a roll mill for 24 hours to obtain a coating liquid for a charge transporting layer. As the bisphenol Z-type polycarbonate resin, “Iupizeta PCZ-200” manufactured by MITSUBISHI GAS CHEMICAL COMPANY, INC. was used. As the leveling agent, dimethylsilicone oil (“KF96-50CS” manufactured by Shin-Etsu Chemical Co., Ltd.) was used. Subsequently, the coating liquid for a charge transporting layer was applied onto the charge generating layer by a dip coating method. The applied coating liquid for a charge transporting layer was dried at 120° C. for 40 minutes to form a charge transporting layer (film thickness: 25 μm) on the intermediate layer.

### (Formation of Protective Layer)

A protective layer of the stacked photoreceptor (C-1) was formed in the same manner as in the formation of the protective layer of the single-layer photoreceptor (A-1) except that the coating liquid for a protective layer was applied onto the charge transporting layer instead of onto the single-layer photosensitive layer.

### [Measurement of Stacked Photoreceptor]

The residual ratio Z of the hole transporting agent of the stacked photoreceptor (C-1) was measured in the same manner as in the measurement of the residual ratio Z of the hole transporting agent of the single-layer photoreceptor. The measurement results are shown in Table 2.

### [Evaluation of Stacked Photoreceptor]

The wear resistance, the suppression of an overshoot, and the sensitivity characteristics of the stacked photoreceptor (C-1) were measured by the following method.

### <Wear Resistance>

The wear resistance of the stacked photoreceptor was evaluated in the same manner as in the evaluation of the wear resistance of the single-layer photoreceptor except that a color printer (“C711dn” manufactured by Oki Electric Industry Co., Ltd.) was used as an evaluation device. Note that the charge polarity of the charging device included in this evaluation device was the negative polarity. The measured amount of wear is shown in Table 2.

### <Suppression of Overshoot>

The suppression of an overshoot of the stacked photoreceptor was evaluated in the same manner as in the evaluation of the suppression of an overshoot of the single-layer photoreceptor except that one obtained by modifying the charge polarity of the evaluation device used to evaluate the suppression of an overshoot of the single-layer photoreceptor to the negative polarity was used as an evaluation device. The charging potential of the first rotation of the photoreceptor was represented by V001 (unit: −V) and the charging potential of the 10th rotation of the photoreceptor was represented by V010 (unit: −V). Since the charge polarity of the stacked photoreceptor was modified to the negative polarity, both V001 and V010 had negative values. The measured Vos is shown in Table 2. Note that Vos shown in Table 2 has a positive value.

### <Sensitivity Characteristics>

The sensitivity characteristics of the stacked photoreceptor were evaluated in the same manner as in the evaluation of the sensitivity characteristics of the single-layer photoreceptor except that the surface of the photoreceptor was charged to −550 V instead of +550 V. The measured VL is shown in Table 2.

TABLE 2

| | | Charge transporting layer | | | | | | |
|---|---|---|---|---|---|---|---|---|
| | | HTM | | | | | | |
| | | | | Residual | | | Wear | |
| | Stacked | | Molecular | ratio Z | Protective | VL | amount | Vos |
| | photoreceptor | Type | weight | [%] | layer | [−V] | [μm] | [V] |
| Ex9 | C-1 | HTM-1 | 777.0 | 97.1 | With | 115 | 0.1 | 4 |

In Table 2, “Ex” and “HTM” are synonymous with the terms described in the above Table 1.

As shown in Table 1, the hole transporting agent included in the charge transporting layer of the stacked photoreceptor (C-1) was a predetermined hole transporting agent. The stacked photoreceptor (C-1) included a protective layer. The stacked photoreceptor (C-1) was capable of suppressing the overshoot of a charging potential and had excellent wear resistance. Further, the stacked photoreceptor (C-1) had excellent sensitivity characteristics.

From the above, it has been shown that the photoreceptor according to the present invention, which includes the single-layer photoreceptors (A-1) to (A-8) and the stacked photoreceptor (C-1), is capable of suppressing the overshoot of a charging potential and has excellent wear resistance. Further, the process cartridge and image forming apparatus according to the present invention include such a photoreceptor, and thus, it can be judged that they are capable of suppressing the overshoot of the charging potential of the photoreceptor and has excellent wear resistance of the photoreceptor.

### INDUSTRIAL APPLICABILITY

The photoreceptor according to the present invention can be used in an image forming apparatus. The process cartridge and image forming apparatus according to the present invention can be used to form an image on a recording medium.

1. An electrophotographic photoreceptor, comprising:
a conductive substrate;
a photosensitive layer; and
a protective layer,
the protective layer being a top surface layer of the electrophotographic photoreceptor and including a photocurable resin,
the photosensitive layer including a charge generating agent and a hole transporting agent,
the hole transporting agent including a compound that has a molecular weight of 580 or more and is represented by a formula (1), (2), (3), or (4). 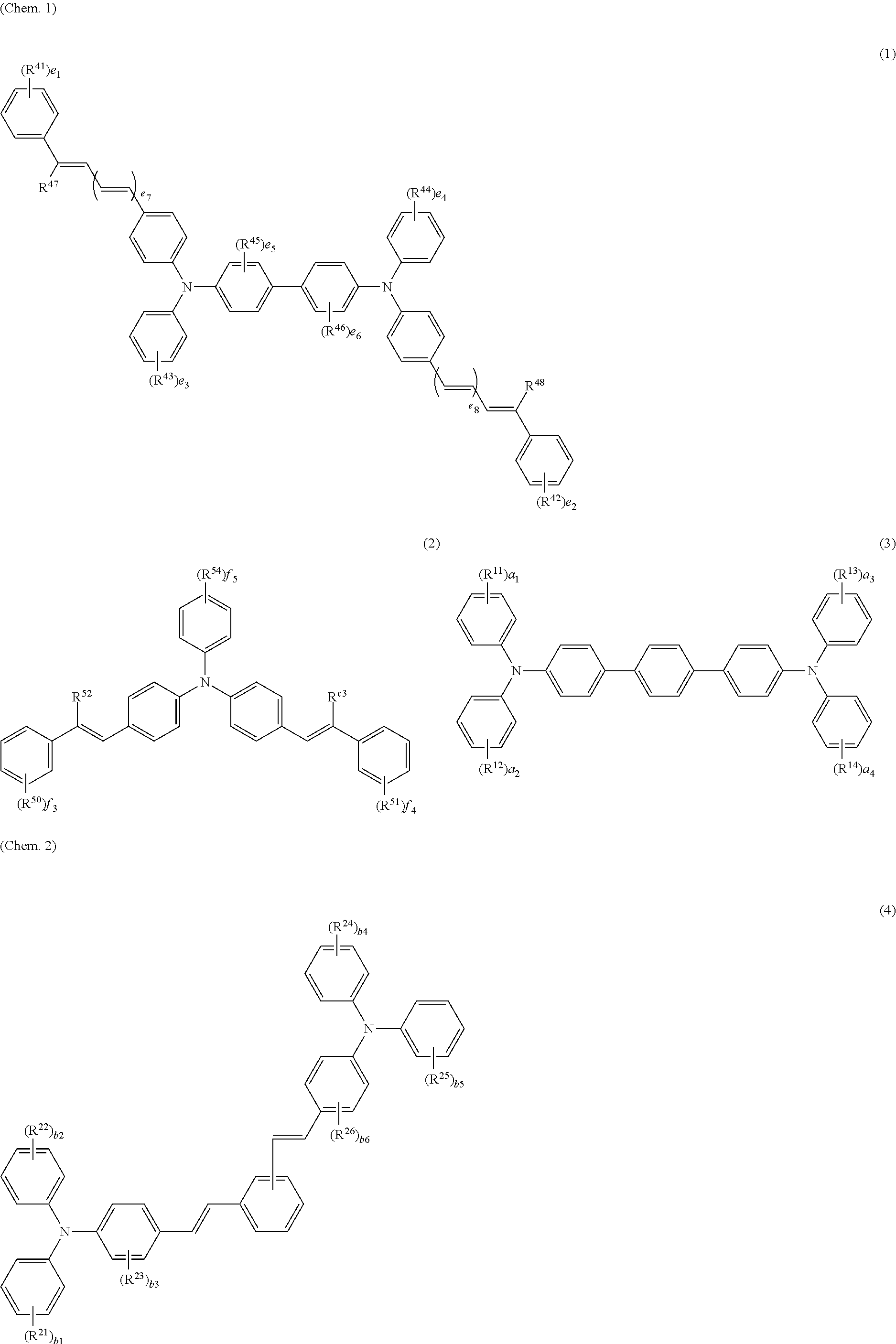
(In the formula (1), R⁴¹, R⁴², R⁴³, R⁴⁴, R⁴⁵, and R⁴⁶ each independently represent an alkyl group having 1 or more and 8 or less carbon atoms or a phenyl group, R⁴⁷ and R⁴⁸ each independently represent a hydrogen atom, an alkyl group having 1 or more and 8 or less carbon atoms, or a phenyl group, e₁, e₂, e₃, and e₄ each independently represent an integer of 0 or more and 5 or less, e₅ and e₆ each independently represent an integer of 0 or more and 4 or less, and e₇ and es each independently represent 0 or 1,
in the formula (2), R⁵⁰, R⁵¹, and R⁵⁴ each independently represent an alkyl group having 1 or more and 8 or less carbon atoms or a phenyl group, R⁵² and R⁵³ each independently represent a hydrogen atom, an alkyl group having 1 or more and 8 or less carbon atoms, or a phenyl group that may be substituted with an alkyl group having 1 or more and 8 or less carbon atoms, and f₃, f₄, and f₅ each independently represent an integer of 0 or more and 5 or less,
in the formula (3), R¹¹, R¹², R¹³, and R¹⁴ each independently represent an alkyl group having 1 or more and 8 or less carbon atoms or a phenyl group, a₁, a₂, a₃, and a₄ each independently represent an integer of 0 or more and 5 or less, and
in the formula (4), R²¹, R²², R²³, R²⁴, R^{2′}, and R²⁶ each independently represent an alkenyl group having 2 or more and 6 or less carbon atoms that may be substituted with at least one phenyl group or an alkyl group having 1 or more and 8 or less carbon atoms, b₁, b₂, b₄, and b₅ each independently represent an integer of 0 or more and 5 or less, and b₃ and b₆ each independently represent an integer of 0 or more and 4 or less.)

2. The electrophotographic photoreceptor according to claim 1, wherein
a residual ratio after irradiation of ultraviolet rays of the hole transporting agent included in the photosensitive layer is 75% or more and the residual ratio after irradiation of ultraviolet rays is calculated by a calculation formula (I).
$$Z = 100 \times ( A 2 / A 1 ) \qquad ( I )$$
(In the formula (I),
Z represents the residual ratio after irradiation of ultraviolet rays,
A1 represents absorbance of a measurement target at a wavelength of 365 nm before irradiation of predetermined ultraviolet rays having a wavelength of 365 nm and an accumulated light amount of 34200 mW-s,
A2 represents absorbance of the measurement target at a wavelength of 365 nm after irradiation of the predetermined ultraviolet rays, and the measurement target is a sheet in which the hole transporting agent is dispersed in a bisphenol Z-type polycarbonate resin.)

3. The electrophotographic photoreceptor according to claim 1, wherein
the hole transporting agent included in the photosensitive layer is a compound represented by a formula (HTM-1), (HTM-2), (HTM-3), (HTM-4), (HTM-5), (HTM-6), (HTM-7), or (HTM-8).

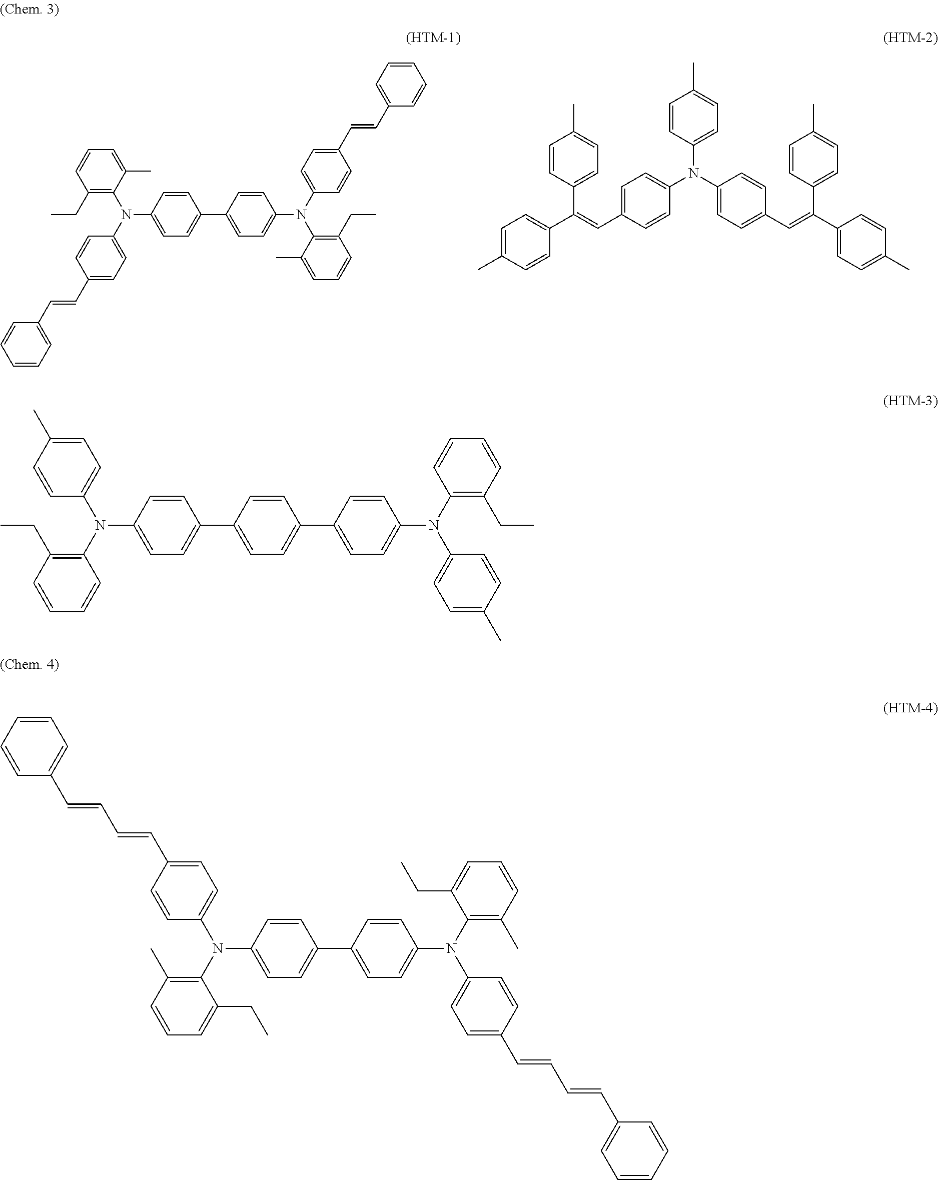

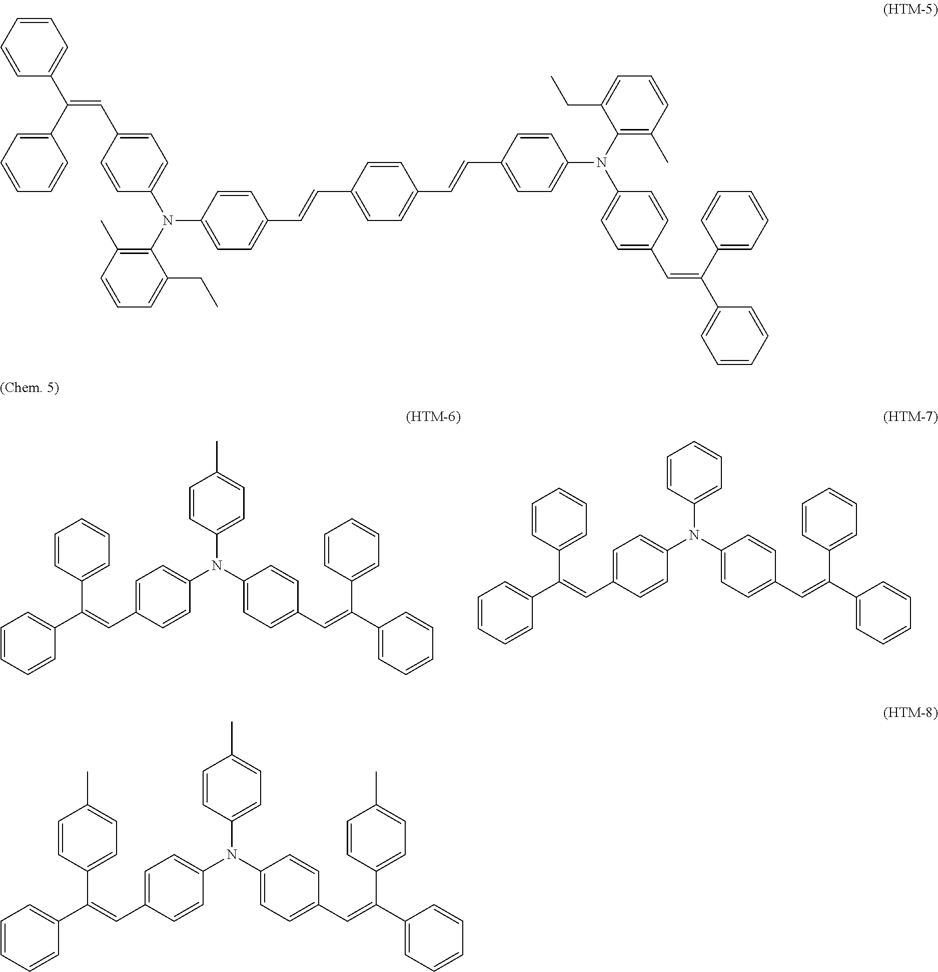

4. The electrophotographic photoreceptor according to claim 3, wherein
the hole transporting agent included in the photosensitive layer is the compound represented by the formula (HTM-4), (HTM-5), (HTM-6), (HTM-7), or (HTM-8).

5. The electrophotographic photoreceptor according to claim 1, wherein
the photocurable resin included in the protective layer includes a repeating unit derived from a compound having two or more vinyl groups.

6. The electrophotographic photoreceptor according to claim 5, wherein
the repeating unit derived from a compound having two or more vinyl groups is a repeating unit derived from at least one selected from the group consisting of compounds represented by formulae (EA-1) and (EA-2).

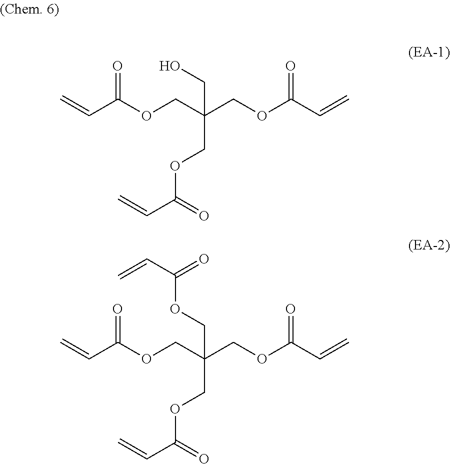

7. The electrophotographic photoreceptor according to claim 1, wherein
the protective layer has a thickness of 0.5 μm or more and 2.0 μm or less.

8. The electrophotographic photoreceptor according to claim 1, wherein
the charge generating agent included in the photosensitive layer contains titanyl phthalocyanine.

9. The electrophotographic photoreceptor according to claim 1, wherein
the photosensitive layer is a single layer,
the photosensitive layer further includes an electron transporting agent, and
the electron transporting agent includes at least one of compounds represented by formulae (11) and (16). 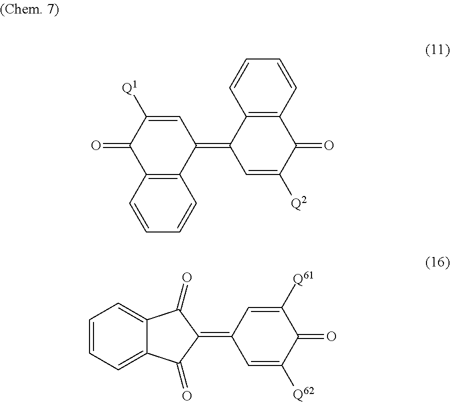
(Q¹ and Q² in the formula (11) and Q⁶¹ and Q⁶² in the formula (16) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms, which may be substituted with at least one substituent group selected from the group consisting of an alkyl group having 1 or more and 6 or less carbon atoms and a halogen atom.)

10. The electrophotographic photoreceptor according to claim 1, wherein
the photosensitive layer includes a charge generating layer and a charge transporting layer,
the charge generating layer includes the charge generating agent, and
the charge transporting layer includes the hole transporting agent.

11. A process cartridge, comprising:
at least one selected from the group consisting of a charging device, an exposure device, a development device, a transfer device, a cleaning member, a rubbing roller, and a static elimination device; and
the electrophotographic photoreceptor according to claim 1.

12. An image forming apparatus, comprising:
an image carrier;
a charging device that charges a surface of the image carrier;
an exposure device that exposes the charged surface of the image carrier to form an electrostatic latent image on the surface of the image carrier;
a development device that supplies a toner to the surface of the image carrier to develop the electrostatic latent image as a toner image; and
a transfer device that transfers the toner image from the image carrier onto a to-be-transferred body,
the image carrier being the electrophotographic photoreceptor according to claim 1.

13. The image forming apparatus according to claim 12, further comprising
at least one selected from the group consisting of
a cleaning member that collects the toner adhering to the surface of the image carrier,
a rubbing roller that rubs the surface of the image carrier, and
a static elimination device that eliminates static electricity on the surface of the image carrier.

14. The image forming apparatus according to claim 12, wherein
the charging device is a charging roller.

15. The image forming apparatus according to claim 12, wherein
the development device supplies the toner charged due to friction with a carrier to the surface of the image carrier.
